(19) United States
(12) Patent Application Publication
(10) Pub. No.: US 2025/0250721 A1
(43) Pub. Date: Aug. 7, 2025

(54) CARBON FIBER AND METHOD OF PRODUCING CARBON FIBER

(71) Applicants: KABUSHIKI KAISHA TOYOTA CHUO KENKYUSHO, Nagakute-shi (JP); TOYOTA JIDOSHA KABUSHIKI KAISHA, Toyota-shi (JP)

(72) Inventors: Takuya MORISHITA, Nagakute-shi (JP); Mamiko NARITA, Nagakute-shi (JP); Hiroyuki MORI, Nagakute-shi (JP); Shota TANIGUCHI, Nagakute-shi (JP); Natsu SAKAKURA, Nagakute-shi (JP); Akira KUNITOMO, Toyota-shi (JP)

(73) Assignees: KABUSHIKI KAISHA TOYOTA CHUO KENKYUSHO, Nagakute-shi (JP); TOYOTA JIDOSHA KABUSHIKI KAISHA, Toyota-shi (JP)

(21) Appl. No.: 19/042,724

(22) Filed: Jan. 31, 2025

(30) Foreign Application Priority Data
Feb. 1, 2024 (JP) 2024-014488

(51) Int. Cl. D01F 9/21; C01B 32/05

(52) U.S. Cl. CPC D01F 9/21; C01B 32/05; D10B 2401/063

(57) ABSTRACT

A carbon fiber, which has a phosphorus content of from 0.6% by mass to 10% by mass, a nitrogen content of 5% by mass or less, and an oxygen content of 0.3% by mass or less, obtained from elemental analysis of the carbon fiber, and which has a single filament tensile modulus of 150 GPa or more.

### CROSS-REFERENCE TO RELATED APPLICATION

This application claims priority under 35 U.S.C. § 119 from Japanese Patent Application No. 2024-014488 filed on Feb. 1, 2024, the entire disclosure of which is incorporated herein by reference.

### BACKGROUND

### Technical Field

The present disclosure relates to a carbon fiber and a method of producing a carbon fiber.

### Related Art

Carbon fibers are lightweight and have excellent mechanical properties. Thus, carbon fiber composite materials are being developed for a variety of applications, such as aerospace, automotive, and building materials.

A known method of producing a carbon fiber involves performing a stabilization treatment and then a carbonization treatment on a fiber bundle obtained by spinning polyacrylonitrile or pitch as a precursor (e.g., Japanese Patent Application Laid-Open (JP-A) No. 2006-183159, JP-A No. 2008-202208, and JP-A No. H06-10215).

Polyacrylonitrile-based carbon fibers made from fibers obtained by spinning polyacrylonitrile have high mechanical properties and are thus most widely used. However, since spinning is carried out by wet spinning or dry and wet spinning using organic solvents such as dimethylsulfoxide or dimethylformamide, energy is required to recycle the organic solvents, which could lead to higher manufacturing costs.

Meanwhile, when pitch is used as a raw material, it can be spun by melt spinning without using organic solvents, and hydrogen cyanide is not generated during stabilization and carbonization treatments. However, melt spinning of pitch-based fibers generally requires high temperatures of 250° C. or more. In addition, pitch-based fibers are relatively brittle and tend to have inter-fiber fusion or yarn breakage during a stabilization treatment.

An acrylamide-based polymer containing an acrylamide-based monomer as a precursor of carbon fibers or the like is a water-soluble polymer. When polymerization, spinning, or the like is performed, water, which is inexpensive and has a small environmental impact, can be used as a solvent. This is expected to reduce the manufacturing costs of carbon materials (e.g., JP-A No. 2022-85514 and JP-A No. 2022-143757).

In carbon material precursors containing an acrylamide-based polymer as described in JP-A No. 2022-85514 and JP-A No. 2022-143757, inter-fiber fusion may occur due to softening during a heating treatment, particularly during a stabilization treatment. For this reason, there is a concern that inter-fiber fusion may occur in the obtained carbon fibers. Once inter-fiber fusion occurs, there is a risk that the strength of the fused portion of carbon fiber will decrease, or that the fused portion will break and cause fluff or the like.

In addition, once fluff is formed due to thermal decomposition or the like of a fiber during carbonization, it may lead to further fluff generation and result in poor handling properties when the carbon fiber is unwound from a core for use in a carbon fiber composite material or the like after the carbon fiber is wound around the core or the like following carbonization.

### SUMMARY

JP-A No. 2022-143757 describes that a high-strength carbon fiber having specific physical properties can be obtained by performing a heating treatment on a stabilized fiber under an inert gas atmosphere while applying tension. Depending on the tension conditions in a stretching treatment, yarn breakage and fluff generation may occur during pre-carbonization.

An object of an embodiment of the present disclosure is to provide a carbon fiber in which inter-fiber fusion is suppressed, fluff generation during unwinding of the carbon fiber is suppressed, and which has high tensile strength and tensile modulus, and a method of producing a carbon fiber.

The present disclosure includes the following aspects.

<1> A carbon fiber, which has a phosphorus content of from 0.6% by mass to 10% by mass, a nitrogen content of 5% by mass or less, and an oxygen content of 0.3% by mass or less, obtained from elemental analysis of the carbon fiber, and which has a single filament tensile modulus of 150 GPa or more.

<2> The carbon fiber according to <1>, which is in a form of a carbon fiber bundle consisting of 800 fibers, in which a fusion rate of the carbon fibers included in the carbon fiber bundle is 15% or less.

<3> The carbon fiber according to <1> or <2>, which is a carbon fiber derived from an acrylamide-based polymer fiber.

<4> The carbon fiber according to <1> or <2>, which has a single filament tensile strength of 1.4 GPa or more.

<5> A method of producing a carbon fiber, the method including performing a stabilization treatment on a spread fiber bundle prepared by fiber spreading of an acrylamide-based polymer fiber, in which the acrylamide-based polymer fiber has a phosphorus content of from 0.1% by mass to 10% by mass by elemental analysis.

<6> The method of producing a carbon fiber according to <5>, further including performing a carbonization treatment on the stabilized acrylamide-based polymer fiber.

<7> The method of producing a carbon fiber according to <6>, in which: the stabilized acrylamide-based polymer fiber has a phosphorus content of from 0.1% by mass to 10% by mass by elemental analysis, a maximum temperature when performing the carbonization treatment is in a range of from 1350° C. to 1650° C., and the carbonized fiber bundle has a carbon fiber fusion rate of 20% or less.

According to the present disclosure, a carbon fiber in which inter-fiber fusion is suppressed, fluff generation during unwinding of the carbon fiber is suppressed, and which has high tensile strength and tensile modulus, and a method of producing a carbon fiber can be provided.

### BRIEF DESCRIPTION OF THE DRAWING

FIG. 1 is a schematic diagram showing one embodiment of a fiber spreader that can be used in the method of producing a carbon fiber of the present disclosure.

### DESCRIPTION OF EMBODIMENTS

In the present disclosure, the numerical ranges indicated using “to” include the numerical values before and after “to” as the minimum and maximum values, respectively.

In the present disclosure, in the numerical ranges described stepwise, the upper or lower limit value described in one numerical range may be replaced with the upper or lower limit value of another numerical range described stepwise. In the numerical ranges described in the present disclosure, the upper or lower limit of the numerical ranges may be replaced with values shown in the Synthesis Examples.

In the present disclosure, each component may contain a plurality of kinds of corresponding substances. When a plurality of substances corresponding to each component are present in the carbon fiber precursor, the content or amount of each component means the total content or amount of the plurality of substances present in the carbon fiber precursor, unless otherwise specified.

The term “carbon fiber” used in the present disclosure encompasses a “carbon fiber single filament” and a “carbon fiber bundle consisting of a plurality of carbon fiber single filaments”.

The term “carbon fiber precursor” in the present disclosure means a fiber from which a carbon fiber can be obtained by performing a carbonization treatment or stabilization and carbonization treatments.

The term “acrylamide-based polymer” in the present disclosure means a homopolymer of an acrylamide-based monomer or a copolymer of an acrylamide-based monomer and a monomer other than an acrylamide-based monomer (hereinafter referred to as “another polymerizable monomer”).

### <Carbon Fiber>

The carbon fiber of the present disclosure is a carbon fiber, which has a phosphorus content of from 0.6% by mass to 10% by mass, a nitrogen content of 5% by mass or less, and an oxygen content of 0.3% by mass or less, obtained from elemental analysis of the carbon fiber, and which has a single filament tensile modulus of 150 GPa or more.

The carbon fiber of the present disclosure has a phosphorus content of from 0.6% by mass to 10% by mass obtained by elemental analysis and thus is excellent in inter-fiber fusion suppression and suppression of fluff generation in the carbon fiber during unwinding, and also has a high tensile strength and a high tensile modulus.

The reasons why the above-described effects are achieved are presumed to be as follows, but are not limited thereto.

The carbon fiber of the present disclosure contains a specified amount of phosphorus and has low nitrogen and oxygen contents. It is therefore considered that the fusion of adjacent fibers caused by nitrogen and oxygen on the fiber surface is effectively suppressed, and as a result, the generation of fluff is suppressed, and the decrease in strength and the decrease in tensile modulus caused by the inter-fiber fusion portion are suppressed.

In particular, it is presumed that even in a case in which an acrylamide-based polymer fiber, which can be synthesized in a water-based system and is excellent in terms of environmental burden, is used as a raw material for a carbon fiber, since the phosphorus content is specified and the nitrogen and oxygen contents are low, softening during a stabilization treatment can be suppressed, and fusion between single filaments can be suppressed. It is therefore presumed that the effects of the present disclosure are remarkable in a case in which an acrylamide-based polymer fiber is used as the raw material for a carbon fiber.

### <Elemental Content in Carbon Fiber>

The carbon fiber of the present disclosure has a phosphorus content of from 0.6% by mass to 10% by mass, a nitrogen content of 5% by mass or less, and an oxygen content of 0.3% by mass or less, obtained from elemental analysis.

The carbon fiber of the present disclosure has a phosphorus content of from 0.6% by mass to 10% by mass obtained by elemental analysis. From the viewpoint of further improving inter-fiber fusion suppression and suppression of fluff generation during unwinding of the carbon fiber that has been wound onto a core (paper tube, core, winding rod, bobbin, or the like) or a winding plate after carbonization, the phosphorus content is preferably from 0.7% by mass to 5.0% by mass, more preferably from 1.0% by mass to 2.0% by mass, and still more preferably from 1.1% by mass to 1.8% by mass.

The elemental analysis of the phosphorus content in the carbon fiber can be carried out by the following method using a carbon fiber that has been dried at 120° C. for 1 hour under atmospheric pressure as a sample.

The carbon fiber is heated and incinerated, then dissolved in acid, and the phosphorus content of the resulting solution is determined using inductively coupled plasma mass spectrometry (ICP-MS). As a measuring apparatus for the ICP-MS method, NexION2000C (manufactured by PerkinElmer) can be used.

The acid that can be used to dissolve the carbonized carbon fiber can be selected, as appropriate. Examples of acids that can be used for dissolution include, but are not limited to, nitric acid, aqua regia, and hydrofluoric acid.

The means of adjusting the phosphorus content in the carbon fiber to the above-described range is preferably a method of adding the following to an acrylamide-based polymer when preparing an acrylamide-based polymer, when preparing an acrylamide-based polymer fiber as a carbon fiber precursor, or when preparing a stabilized fiber, or the like: phosphorus compounds, for example, phosphoric acid, polyphosphoric acid, and their metal salts (sodium salt, potassium salt, calcium salt, and the like), salts such as ammonium salts, amine salts, guanidine salts, urea salts, melamine salts, and imidazole salts; aromatic phosphate esters such as triphenyl phosphate, cresyl diphenyl phosphate, tricresyl phosphate, trixylenyl phosphate, tris(i-propylated phenyl) phosphate, tris(t-butylated phenyl) phosphate, and 2-ethylhexyl diphenyl phosphate; aromatic condensed phosphate esters such as 1,3-phenylene bis(diphenyl phosphate), 1,3-phenylene bis(dixylenyl) phosphate, resorcinol bis(diphenyl) phosphate, and bisphenol A bis(diphenyl phosphate); halogen-containing phosphate esters such as tris(dichloropropyl) phosphate, tris(β-chloropropyl) phosphate, and tris(chloroethyl) phosphate; and halogen-containing condensed phosphate esters such as 2,2-bis(chloromethyl) trimethylenebis(bis(2-chloroethyl) phosphate) and polyoxyalkylenebisdichloroalkylphosphates, cyclic phosphazene compounds, phosphorus pentoxide, and phosphorus oxychloride. From the viewpoint that the phosphorus-based compound also functions as a catalyst for the cyclization reaction and dehydration reaction during the stabilization and that the stabilization and carbonization yield are improved, a method of adding phosphoric acid, polyphosphoric acid, or an ammonium salt thereof (diammonium hydrogen phosphate, ammonium dihydrogen phosphate, or the like) is preferable.

The amount added with respect to 100 parts by mass of the acrylamide-based polymer is preferably from 0.3 parts by mass to 10 parts by mass, more preferably from 1 part by mass to 5 parts by mass, and still more preferably from 2 parts by mass to 4 parts by mass.

Examples of the means of adjusting the phosphorus content in the carbon fiber to 0.6% by mass or more include a method of adjusting the amount of a phosphorus-based compound added to the lower limit or more of the above-described preferred range, as well as from the viewpoint of suppressing the loss of a phosphorus-based compound and/or a product derived therefrom due to thermal decomposition during a carbonization treatment, a method of adjusting the carbonization treatment temperature to 1800° C. or less, preferably 1750° C. or less, and more preferably 1700° C. or less.

The nitrogen content in the carbon fiber of the present disclosure obtained by elemental analysis is 5% by mass or less, preferably 4% by mass or less, more preferably 3% by mass or less, still more preferably 2% by mass or less, and particularly preferably 1.5% by mass or less.

The lower limit of the nitrogen content in the carbon fiber is not particularly limited, and it may be 0% by mass, which is the detection limit or less in elemental analysis.

When the nitrogen content in the carbon fiber exceeds 5% by mass, the fusion rate of a carbonized fiber bundle increases, which is not preferable.

Examples of the means of adjusting the nitrogen content in the carbon fiber to 5% by mass or less include a method in which the carbonization treatment temperature is set to from 1300° C. to 1750° C. and preferably from 1350° C. to 1650° C.

The oxygen content in the carbon fiber of the present disclosure obtained by elemental analysis is 0.3% by mass or less, preferably 0.2% by mass or less, more preferably 0.15% by mass or less, and still more preferably 0.1% by mass or less.

The lower limit of the oxygen content in the carbon fiber is not particularly limited, and it may be 0% by mass, which is the detection limit or less in elemental analysis.

When the oxygen content in the carbon fiber exceeds 0.3% by mass, the fusion rate of a carbonized fiber bundle increases, which is not preferable.

Examples of the means of adjusting the oxygen content in the carbon fiber to 0.3% by mass or less include: a method in which the carbonization treatment temperature is set to 1300° C. or more, preferably 1350° C. or more, more preferably 1400° C. or more, and still more preferably 1450° C. or more; and a method in which at least one of pre-carbonization or carbonization of the stabilized fiber is performed in an inert gas atmosphere with a low oxygen concentration. The oxygen concentration in an inert gas atmosphere is preferably 30 ppm or less, more preferably 20 ppm or less, still more preferably 10 ppm or less, and particularly preferably 5 ppm or less.

The nitrogen and oxygen contents can be obtained by elemental analysis.

The elemental analysis can be performed by the method described below using a carbon fiber dried at 120° C. for 1 hour under atmospheric pressure as a measurement sample.

The detection method using an oxygen circulation combustion/thermal conductivity detector (TCD) detection method is used as the analysis method.

As a measuring apparatus, for example, SUMIGRAPH NCH-22F (manufactured by Sumika Chemical Analysis Service, Ltd.) can be used, and the elemental analyses in the present disclosure describe values measured using the apparatus.

Measurement principles: Each measurement sample is decomposed and completely oxidized by burning it for 15 minutes while circulating O₂ gas using a gas chromatograph equipped with a TCD. The carbon component is converted into CO₂ and the nitrogen component is converted into N₂ gas, and then can be detected and quantitatively determined.

The amount of oxygen in the carbon fiber is determined by drying the carbon fiber at 120° C. under atmospheric pressure for 1 hour as a sample, and measuring the amount of oxygen in the carbon fiber by impulse heating and melting in an inert gas-non-dispersive infrared absorption (NDIR) detection method.

EMGA-920 (manufactured by HORIBA, Ltd.) can be used as the apparatus. According to the measurement principles, a sample is placed in a graphite crucible, and a current is passed through the graphite crucible in He gas (oxygen-free), thereby melting the sample at about 2500° C. The oxygen component is converted into CO gas, and then the amount of oxygen is detected and quantitatively determined.

The quantitative determination of nitrogen in carbon fiber is carried out in the same manner as above, by drying carbon fiber at 120° C. under atmospheric pressure for 1 hour as a sample, converting it into N₂ gas, and using the detected value as a reference.

### <Precursor Fiber of Carbon Fiber>

Raw materials for a precursor fiber of a carbon fiber are not particularly limited. Examples thereof may include known raw materials, for example, an acrylonitrile-based polymer (i.e., a homopolymer or copolymer containing acrylonitrile monomer units), an acrylamide-based polymer (i.e., a homopolymer or copolymer containing acrylamide monomer units), and mixtures thereof.

Of these, an acrylamide-based polymer is preferable. In other words, the carbon fiber of the present disclosure is preferably a carbon fiber derived from an acrylamide-based polymer fiber.

### (Acrylamide-Based Polymer Fiber)

An acrylamide-based polymer fiber that is suitably used for the carbon fiber of the present disclosure contains one or more kinds of acrylamide-based polymers.

The single filament tensile modulus of the carbon fiber of the present disclosure is preferably 150 GPa or more, more preferably 160 GPa or more, still more preferably 170 GPa or more, and particularly preferably 180 GPa or more.

The single filament tensile strength of the carbon fiber of the present disclosure is preferably 1.4 GPa or more, more preferably 1.5 GPa or more, still more preferably 1.8 GPa or more, and particularly preferably 2.0 GPa or more.

From the viewpoint of fusion suppression or the like, the acrylamide-based polymer fiber is preferably a crosslinked acrylamide-based polymer fiber containing a crosslinked acrylamide-based polymer.

The crosslinked acrylamide-based polymer fiber in the present disclosure means an acrylamide-based polymer fiber that is crosslinked by active ray irradiation (e.g., electron beam irradiation or ultraviolet light irradiation), heating, or the like. The crosslinked acrylamide-based polymer may be a homopolymer of an acrylamide-based monomer or a copolymer of an acrylamide-based monomer and a monomer other than an acrylamide-based monomer (hereinafter referred to as “another polymerizable monomer”).

The content of acrylamide-based monomer units in the acrylamide-based polymer is preferably 30 mol % or more, more preferably 40 mol % or more, still more preferably 50 mol % or more, particularly preferably 55 mol % or more, and most preferably 60 mol % or more.

Since the content of acrylamide-based monomer units is 30 mol % or more, the solubility of the acrylamide-based polymer in an aqueous solvent or an aqueous mixed solvent tends to be improved.

In addition, the upper limit of the content of acrylamide-based monomer units is not particularly limited. However, from the viewpoint of fusion suppression or the like, it is preferably 99.9 mol % or less, more preferably 99 mol % or less, still more preferably 95 mol % or less, particularly preferably 90 mol % or less, and most preferably 85 mol % or less.

The content of acrylamide-based monomer units is preferably from 30 mol % to 99.9 mol %.

In a case in which the acrylamide-based polymer is a copolymer of an acrylamide-based monomer and another polymerizable monomer, the content of other polymerizable monomer units in the above-described copolymer is preferably 0.1 mol % or more, more preferably 1 mol % or more, still more preferably 5 mol % or more, particularly preferably 10 mol % or more, and most preferably 15 mol % or more from the viewpoint of fusion suppression or the like.

In addition, from the viewpoint of improving the solubility of the acrylamide-based polymer in an aqueous solvent or an aqueous mixed solvent, the upper limit of the content of other polymerizable monomer units is preferably 70 mol % or less, more preferably 60 mol % or less, still more preferably 50 mol % or less, particularly preferably 45 mol % or less, and most preferably 40 mol % or less.

The content of other polymerizable monomer units is preferably from 0.1 mol % to 70 mol %.

Examples of the acrylamide-based monomer include: acrylamide; methacrylamide; crotonamide; itaconic acid diamide; cinnamic acid amide; maleic acid diamide; N-alkylacrylamides such as N-methylacrylamide, N-ethylacrylamide, N-n-propylacrylamide, N-isopropylacrylamide, N-n-butylacrylamide, and N-tert-butylacrylamide; N-cycloalkylacrylamides such as N-cyclohexylacrylamide; dialkylacrylamides such as N,N′-dimethylacrylamide; dialkylaminoalkylacrylamides such as dimethylaminoethylacrylamide and dimethylaminopropylacrylamide; hydroxyalkylacrylamides such as N-(hydroxymethyl)acrylamide and N-(hydroxyethyl)acrylamide; N-arylacrylamides such as N-phenylacrylamide; diacetone acrylamide; N,N′-alkylenebisacrylamides such as N,N′-methylenebisacrylamide; methacrylamides: N-alkyl methacrylamides such as N-methyl methacrylamide, N-ethyl methacrylamide, N-n-propyl methacrylamide, N-isopropyl methacrylamide, N-n-butyl methacrylamide, and N-tert-butyl methacrylamide; N-cycloalkyl methacrylamides such as N-cyclohexyl methacrylamide; dialkyl methacrylamides such as N,N-dimethylmethacrylamide; dialkylaminoalkyl methacrylamides such as dimethylaminoethyl methacrylamide and dimethylaminopropyl methacrylamide; hydroxyalkyl methacrylamides such as N-(hydroxymethyl) methacrylamide and N-(hydroxyethyl) methacrylamide; N-arylmethacrylamides such as N-phenylmethacrylamide; diacetone methacrylamide; N,N′-alkylene bismethacrylamides such as N,N′-methylene bismethacrylamide.

In addition, from the viewpoint of solubility of the acrylamide-based polymer in an aqueous solvent or an aqueous mixed solvent, among the above-described acrylamide-based monomers, acrylamide, N-alkylacrylamide, dialkylacrylamide, methacrylamide, N-alkyl methacrylamide, or dialkyl methacrylamide is preferable, and acrylamide is more preferable.

The acrylamide-based monomer may be used singly, or in combination of two or more kinds thereof.

Examples of other polymerizable monomers include vinyl cyanide-based monomers, unsaturated carboxylic acids and their salts, unsaturated carboxylic anhydrides, unsaturated carboxylic acid esters, vinyl alcohol-based monomers, vinyl carboxylate-based monomers, and olefin monomers.

Examples of vinyl cyanide-based monomers include acrylonitrile, methacrylonitrile, 2-hydroxyethyl acrylonitrile, chloroacrylonitrile, chloromethyl acrylonitrile, ethoxyacrylonitrile, and vinylidene cyanide.

Examples of unsaturated carboxylic acids include acrylic acid, methacrylic acid, maleic acid, fumaric acid, itaconic acid, citraconic acid, mesaconic acid, crotonic acid, and isocrotonic acid.

Examples of salts of unsaturated carboxylic acids include metal salts (e.g., sodium salts and potassium salts), ammonium salts, and amine salts of unsaturated carboxylic acids.

Examples of unsaturated carboxylic anhydrides include maleic anhydride and itaconic anhydride.

Examples of unsaturated carboxylic acid esters include methyl acrylate, methyl methacrylate, 2-hydroxyethyl acrylate, and 2-hydroxyethyl methacrylate.

Examples of vinyl-based monomers include: aromatic vinyl-based monomers such as styrene and α-methylstyrene; vinyl carboxylates such as vinyl acetate, vinyl propionate, vinyl butyrate, and vinyl pivalate; vinyl chloride; and vinyl alcohol.

Examples of olefin-based monomers include ethylene, propylene, isopropylene, and butadiene.

Among the above-described other polymerizable monomers, from the viewpoints of spinnability of the acrylamide-based polymer, fusion suppression, and the like, vinyl cyanide-based monomers are preferable, and acrylonitrile is more preferable.

Among the above-described other polymerizable monomers, from the viewpoint of solubility of the above-described copolymer in an aqueous solvent or an aqueous mixed solvent, unsaturated carboxylic acids and their salts are preferable, and acrylic acid, maleic acid, fumaric acid, or itaconic acid is more preferable.

Among the above-described other polymerizable monomers, from the viewpoint of fusion suppression, an unsaturated carboxylic acid or an unsaturated carboxylic acid anhydride is preferable, and acrylic acid, maleic acid, fumaric acid, itaconic acid, or maleic anhydride is more preferable.

The above-described other polymerizable monomers may be used singly, or in combination of two or more kinds thereof.

From the viewpoints of solubility of the above-described copolymer in an aqueous solvent or an aqueous mixed solvent, spinnability, fusion suppression, and the like, the acrylamide-based polymer is preferably a copolymer of an acrylamide-based monomer and an acrylonitrile-based monomer, more preferably a copolymer of an acrylamide-based monomer, an acrylonitrile-based monomer, and an unsaturated carboxylic acid, and still more preferably a copolymer of acrylamide, acrylonitrile, and acrylic acid.

From the viewpoints of spinnability, fusion suppression, and the like, the content of acrylonitrile-based monomer units in the above-described copolymer is preferably from 1 mol % to 50 mol %, more preferably from 5 mol % to 35 mol %, and still more preferably from 10 mol % to 25 mol %.

From the viewpoints of solubility of the above-described copolymer in an aqueous solvent or an aqueous mixed solvent, fusion suppression, and the like, the content of unsaturated carboxylic acid units in the above-described copolymer are preferably from 0.1 mol % to 20 mol %, more preferably from 1 mol % to 10 mol %, still more preferably from 1 mol % to 8 mol %, and particularly preferably from 2 mol % to 5 mol %. As the preferred numerical range of the content of acrylamide-based monomer units in the above-described copolymer is described above, the description will be omitted here.

The acrylamide-based polymer in the present disclosure may include a water-soluble polymer other than an acrylamide-based polymer and/or a water-insoluble polymer.

Examples of a water-soluble polymer other than an acrylamide-based polymer include vinyl alcohol polymers, alkylene oxide polymers (e.g., polyethylene glycol), polyvinylpyrrolidone, polyacrylic acid, alkyl water-soluble polymers (e.g., isobutylene-maleic anhydride copolymers and copolymers in which at least a portion of the maleic anhydride in the isobutylene-maleic anhydride copolymer has been ammonia-modified or imidized), water-soluble phenolic polymers, carboxyvinyl polymers, and cellulose derivatives (e.g., carboxymethyl cellulose). The above-described water-soluble polymers may be used singly, or in combination of two or more kinds thereof. The water-insoluble polymer is not particularly limited, but examples thereof include polyacrylonitrile-based polymers, diene-based polymers, polyolefin-based polymers, and water-insoluble phenolic polymers, which may be used singly, or in combination of two or more kinds thereof.

In a case in which the acrylamide-based polymer fiber contains a polymer other than an acrylamide-based polymer, from the viewpoints of fusion suppression, water resistance, and the like, the content of the acrylamide-based polymer with respect to the total mass of the acrylamide-based polymer fiber is preferably 50% by mass or more, more preferably 60% by mass or more, and still more preferably 70% by mass or more.

The weight average molecular weight of the acrylamide-based polymer is not particularly limited and is generally 10,000,000 or less. From the viewpoint of molding processability of the carbon fiber precursor, it is preferably 5,000,000 or less, more preferably 2,000,000 or less, still more preferably 1,000,000 or less, yet still more preferably 500,000 or less, particularly preferably 300,000 or less, and most preferably 200,000 or less.

In addition, the lower limit of the weight average molecular weight of the acrylamide-based polymer is not particularly limited and is generally 10,000 or more. However, from the viewpoint of strengths of the carbon fiber precursor and the carbon fiber, it is preferably 20,000 or more, still more preferably 30,000 or more, and particularly preferably 40,000 or more.

The weight average molecular weight in the present disclosure is measured by gel permeation chromatography under the following conditions. As a measuring apparatus, HLC-8220GPC manufactured by Tosoh Corporation or an apparatus equivalent thereto can be used.

### (Measurement Conditions)

Column: TSKgel (registered trademark) GMPWXL (×2)+TSKgel G2500PWXL (×1)
Eluent: 100 mM sodium nitrate aqueous solution/acetonitrile (=80/20 (volume ratio))
Eluent flow rate: 1.0 mL/min
Colum temperature: 40° C.
Molecular weight standard: Standard polyethylene oxide/standard polyethylene glycol
Detector: Refractive index detector

The acrylamide-based polymer fiber of the present disclosure has excellent fusion suppression properties. Thus, it is not necessary to add an additional component such as an acid. However, the acrylamide-based polymer fiber may contain, in addition to the acrylamide-based polymer, at least one additional component selected from the group consisting of acids and salts thereof. By performing a stabilization treatment on the acrylamide-based polymer fiber including additional components, the cyclic structure formation through a dehydration reaction, a deammonia reaction, or the like is accelerated, and the fusion suppression tends to be further improved.

In addition, the additional components and their residues may at least partially remain in the resulting stabilized fiber. Further, a carbonization treatment may be performed by adding additional components to the stabilized fiber.

Examples of acids include inorganic acids such as phosphoric acid, polyphosphoric acid, boric acid, hydrochloric acid, sulfuric acid, nitric acid, and carbonic acid, and organic acids such as oxalic acid, citric acid, and sulfonic acid.

Examples of the salts of the acids include metal salts (such as sodium salts and potassium salts), ammonium salts, amine salts, guanidine salts, urea salts, melamine salts, and imidazole salts. Ammonium salts and amine salts are preferable, and ammonium salts are more preferable.

Among the above-described additional components, from the viewpoints of fusion suppression, carbonization yield, and shape stability, phosphoric acid, polyphosphoric acid, boric acid, sulfuric acid, or ammonium salts thereof are preferable, phosphoric acid, polyphosphoric acid, boric acid, or ammonium salts thereof are more preferable, and phosphoric acid, polyphosphoric acid, ammonium salts of phosphoric acid, or ammonium salts of polyphosphoric acid are still more preferable.

From the viewpoint of fusion suppression, the content of additional components with respect to 100 parts by mass of the acrylamide-based polymer contained in the acrylamide-based polymer fiber is preferably from 0.1 parts by mass to 100 parts by mass, more preferably from 0.2 parts by mass to 50 parts by mass, still more preferably from 0.5 parts by mass to 30 parts by mass, and particularly preferably from 1 part by mass to 20 parts by mass.

The acrylamide-based polymer fiber in the present disclosure may include other additives.

Examples of other additives include antioxidants, release agents, lubricants, plasticizers, colorants, crosslinking assistants (e.g., ultraviolet crosslinking assistants), crosslinking catalysts (e.g., acid catalysts), crosslinking retarders, reinforcing materials (carbon nanotubes, graphene, carbon black, biomass fibers (such as cellulose fibers such as cellulose nanofibers, chitosan nanofibers, and chitin nanofibers), glass fibers, metal fibers, and other fillers), metal salts (such as sodium chloride, calcium chloride, magnesium chloride, zinc chloride, manganese chloride, strontium chloride, calcium nitrate, and magnesium nitrate), UV absorbers, light-shielding agents, light stabilizers, antistatic agents, and compatibilizers.

The acrylamide-based polymer fiber may contain a low molecular weight compound that is crosslinked by active ray irradiation, such as N-vinylacetamide, vinyl acetate monomer, vinylethoxysilane, methacrylic acid, 2-isocyanatoethyl methacrylate, N-vinyl-2-pyrrolidone, N-vinyl-2-caprolactam, triethylene glycol divinyl ether, ethylene dimethacrylate, divinylbenzene, or triallyl isocyanurate, as long as the effects of the acrylamide-based polymer fiber are not impaired.

The acrylamide-based polymer fiber may be in the form of a single filament or a fiber bundle.

An acrylamide-based polymer fiber produced by a conventionally known method may also be used.

The acrylamide-based polymer fiber can be produced by spinning an acrylamide-based polymer, or an acrylamide-based polymer composition containing an acrylamide-based polymer and the above-described additional components and the like.

The spinning method is not particularly limited, and may be, for example, melt spinning, spunbonding, melt blowing, or centrifugal spinning of a molten acrylamide-based polymer or an acrylamide-based polymer composition.

In a case in which the acrylamide-based polymer or the acrylamide-based polymer composition is soluble in an aqueous solvent or an aqueous mixed solvent, from the viewpoints of spinnability, environmental load reduction, costs, and safety, it is preferable to produce an acrylamide-based polymer fiber by dissolving an acrylamide-based polymer or an acrylamide-based polymer composition in an aqueous solvent or an aqueous mixed solvent, and spinning the obtained aqueous solution or aqueous mixed solution.

In the case of synthesizing an acrylamide-based polymer by solution polymerization, it is preferable to adjust a solution of an acrylamide-based polymer to a desired polymer concentration (i.e., polymer content) if necessary, and then spin the solution, thereby producing an acrylamide-based polymer fiber.

In the case of producing an acrylamide-based polymer composition by wet mixing, it is preferable to adjust a solution of an acrylamide-based polymer composition to a desired polymer concentration (polymer content) if necessary, and then spin the solution, thereby producing an acrylamide-based polymer fiber.

The spinning is preferably carried out by dry spinning, wet spinning, dry-wet spinning, gel spinning, flash spinning, or electrospinning. According to the above-described spinning method, an acrylamide-based polymer fiber having a desired fineness and average fiber diameter can be safely produced at low cost.

From the viewpoint of allowing the production of an acrylamide-based polymer fiber safely at a lower cost, it is preferable to use an aqueous solvent as the solvent, and it is more preferable to use water.

Details of the acrylamide-based polymer have been described above, and therefore will not be described here.

An acrylamide-based polymer that is commercially available or synthesized by a conventionally known method may be used.

The synthesis of an acrylamide-based polymer can be carried out by utilizing a known polymerization reaction such as radical polymerization, cationic polymerization, anionic polymerization, or living radical polymerization. Among the above polymerization reactions, radical polymerization is preferable from the viewpoint of reducing the synthesis cost.

The synthesis of an acrylamide-based polymer can be carried out by utilizing a polymerization method such as solution polymerization, suspension polymerization, precipitation polymerization, dispersion polymerization, or emulsion polymerization (e.g., inverse phase emulsion polymerization).

In the case of synthesizing an acrylamide-based polymer by solution polymerization, it is preferable to use a solvent in which the raw material monomer and the resulting acrylamide polymer can be dissolved. From the viewpoint of allowing low-cost and safe synthesis, it is more preferable to use an aqueous solvent or an aqueous mixed solvent, and it is still more preferable to use an aqueous solvent.

The aqueous solvent may be water, alcohol, a mixture of these, or the like, with water being particularly preferable.

The aqueous mixed solvent means a mixed solvent of the above-described aqueous solvent and an organic solvent, and examples of the organic solvent include tetrahydrofuran, dimethylsulfoxide, and dimethylformamide.

Examples of a method of producing an acrylamide-based polymer composition include: a method of directly mixing additional components into a molten acrylamide-based polymer (melt mixing); a method of dry blending an acrylamide-based polymer with additional components (dry mixing); and a method in which an acrylamide-based polymer formed into a fibrous form is immersed or passed through an aqueous solution or aqueous mixed solution containing additional components, or a solution in which the acrylamide-based polymer is not completely dissolved but the additional components are dissolved.

In a case in which an acrylamide-based polymer and additional components are soluble in an aqueous solvent or an aqueous mixed solvent, a method in which the acrylamide-based polymer and the additional components are mixed in an aqueous solvent or an aqueous mixed solvent (wet mixing) is preferable from the viewpoint that the acrylamide-based polymer and the additional components can be mixed uniformly.

In addition, wet mixing may be performed by mixing the additional components in the aqueous solvent or aqueous mixed solvent in which the acrylamide-based polymer has been synthesized.

In wet mixing, from the viewpoint of allowing the production of an acrylamide-based polymer composition safely at a lower cost, it is preferable to use an aqueous solvent as the solvent, and it is more preferable to use water.

In the case of producing the acrylamide-based polymer composition by wet mixing, the solvent may be removed or may not be removed. The method of removing the solvent is not particularly limited, and at least one of known methods such as reduced pressure distillation, reprecipitation, hot air drying, vacuum drying, and freeze drying can be used.

The acrylamide-based polymer fiber may be in the form of a single filament or a fiber bundle. From the viewpoint that carbon fibers used for structural members in aerospace, automotive, and building material applications show high mechanical properties, the acrylamide-based polymer fiber is preferably in the form of a fiber bundle consisting of a plurality of single filaments.

Regarding the number of filaments in a fiber bundle of a carbon fiber precursor in the present disclosure, the number of filaments per fiber bundle is not particularly limited. However, from the viewpoints of productivity of a stabilized fiber and a carbon fiber as well as mechanical properties, it is preferably from 10 to 360000 filaments, more preferably from 50 to 180000 filaments, still more preferably from 100 to 72000 filaments, and particularly preferably from 800 to 36000 filaments. By setting the number of filaments per bundle to 360000 filaments or less, it is possible to suppress the occurrence of uneven firing during a stabilization or carbonization treatment.

In the present disclosure, the carbon fiber fusion rate is based on 800 filaments per fiber bundle.

The fineness of the acrylamide-based polymer fiber is not particularly limited. However, it is preferably from 1×10⁻⁸ tex/fiber to 100 tex/fiber, more preferably from 1×10⁻⁶ tex/fiber to 60 tex/fiber, still more preferably from 1×10⁻³ tex/fiber to 40 tex/fiber, yet still more preferably from 1×10⁻² tex/fiber to 10 tex/fiber, particularly preferably from 2×10⁻² tex/fiber to 2 tex/fiber, and most preferably from 3×10⁻² tex/fiber to 4×10⁻¹ tex/fiber.

By setting the fineness of the acrylamide-based polymer fiber to 1×10⁻⁸ tex/fiber or more, the occurrence of yarn breakage can be suppressed. This tends to improve the ease of winding the carbon fiber precursor and the stability of the stabilization treatment.

By setting the fineness of the acrylamide-based polymer fiber to 100 tex/fiber or less, the difference between the structure near the surface layer and the structure near the center of the carbon fiber obtained by the stabilization treatment can be reduced. This tends to improve the tensile strength and tensile modulus of the carbon fiber.

The fineness of the acrylamide-based polymer fiber in the present disclosure was measured by measuring the mass of the acrylamide-based polymer fiber bundle, calculating the mass per 1000 m as the fineness [tex] of the fiber bundle, and determining the fineness of the single filaments constituting the fiber bundle.

The average fiber diameter of the acrylamide-based polymer fiber is not particularly limited. However, it is preferably from 3 nm to 300 μm, more preferably from 30 nm to 250 μm, still more preferably from 1 μm to 200 μm, particularly preferably from 3 μm to 100 μm, yet particularly preferably from 4 μm to 40 μm, and most preferably from 5 μm to 30 μm, and may be from 6 μm to 20 μm.

By setting the average fiber diameter of the acrylamide-based polymer fiber to 3 nm or more, the stability of the stabilization treatment can be likely improved. By setting the average fiber diameter of the acrylamide-based polymer fiber to 3 nm or more, the occurrence of yarn breakage can be suppressed. This tends to improve the ease of winding the carbon fiber precursor and the stability of the stabilization treatment. By setting the average fiber diameter of the acrylamide-based polymer fiber to 300 μm or less, the difference between the structure near the surface layer and the structure near the center of the carbon fiber obtained by the stabilization treatment can be reduced. This tends to improve the tensile strength and tensile modulus of the carbon fiber.

For the average fiber diameter in the present disclosure, the fiber bundle density of the acrylamide-based polymer fiber is measured using a dry automatic density meter and the average fiber diameter of single filaments constituting the fiber is determined by the following formula. As the dry automatic density meter, AccuPyc II 1340 manufactured by Micromeritics Corporation or an equivalent device can be used.

$$D = {\{ ( Dt \times 4 \times 10 \; 00 ) / ( p \times π \times n ) \}}^{1 / 2}$$

(In the formula,
D represents the average fiber diameter (μm) of single filaments constituting a fiber bundle,
Dt represents the fineness (tex) of the fiber bundle,
ρ represents the density (g/cm³) of the fiber bundle, and
n represents the number of single filaments constituting the fiber bundle,
provided that π is 3.14.)

From the viewpoints of fusion suppression, water resistance, fiber breakage during stretching, and suppression of the generation of fluff or the like, the acrylamide-based polymer fiber is preferably a crosslinked acrylamide-based fiber. The gel fraction of the crosslinked acrylamide-based fiber is preferably 5% or more, more preferably 10% or more, still more preferably 30% or more, yet still more preferably 50% or more, and particularly preferably 70% or more.

From the viewpoint of stretchability of the carbon fiber precursor, the gel fraction of the acrylamide-based polymer fiber is preferably 98% or less and more preferably 95% or less, or may be 100%.

From the viewpoints of fusion suppression, water resistance, and stretchability of the carbon fiber precursor, the gel fraction of the acrylamide-based polymer fiber is preferably from 5% to 98%.

Whether or not the acrylamide-based polymer is crosslinked is confirmed based on the gel fraction of the acrylamide-based polymer fiber. When the gel fraction of the acrylamide-based polymer fiber is 3% or more, it is determined that the acrylamide-based polymer is crosslinked.

### <Fusion Rate of Carbon Fibers in Carbon Fiber Bundle>

For the carbon fiber of the present disclosure, the fusion rate of carbon fibers in the carbon fiber bundle consisting of 800 carbon fibers in the present disclosure is preferably 15% or less, more preferably 10% or less, still more preferably 7% or less, and particularly preferably 5% or less in one embodiment. If the fusion rate measured by the above-described method is 10% or less, it can be said that the level is not problematic in practical use.

The lower limit of the fusion rate is not particularly limited, and it may be, for example, 0%, in a state where carbon fibers are not fused to each other. The fusion rate of carbon fibers can be measured as follows.

A fiber for evaluation (800 filaments/bundle) with a length of 2 cm is cut out from a carbon fiber. A cross-section of the fiber for evaluation is observed using a microscope (“Digital Microscope VHX-7000” manufactured by KEYENCE CORPORATION) for counting the number of filaments. The proportion of the number of filaments with respect to the number of filaments in a carbon fiber precursor before a stabilization treatment can be calculated as the fusion rate.

### <Method of Producing Carbon Fiber>

The method of producing a carbon fiber of the present disclosure includes a step of performing a stabilization treatment on a spread fiber bundle prepared by fiber spreading of an acrylamide-based polymer fiber that is a carbon fiber precursor.

The above-described step is hereinafter also referred to as a “stabilized fiber production step”.

### (Stabilized Fiber Production Step)

The method of producing a carbon fiber of the present disclosure includes a stabilized fiber production step of performing a stabilization treatment on a spread fiber bundle prepared by a fiber spreading treatment of the above-described carbon fiber precursor.

The term “spread fiber bundle” in the present disclosure refers to a fiber bundle that has been subjected to fiber spreading regardless of the number of fiber spreading treatments (number of stages). The term “fiber spreading treatment” in the present disclosure refers to a treatment of separating a fiber bundle consisting of a plurality of single filaments into separated single filaments.

The term “carbon fiber precursor fiber” in the present disclosure refers to a fiber from which a carbon fiber can be obtained by performing a carbonization treatment or stabilization and carbonization treatments.

There is no particular limitation on the method of fiber spreading applied in this disclosure. Preferred methods include fluid, vibration, friction, electrification (static electricity), roller (a roller having a mechanism for fiber spreading in a direction intersecting the longitudinal direction of the fiber bundle), and manual fiber spreading (performing fiber spreading manually). From the viewpoint of reducing damage to a fiber, a fiber spreading treatment using a fluid is preferable.

The fluid applied to a fiber spreading treatment in the present disclosure may be a gas or a liquid, and is preferably a gas. In the present embodiment, air is used as fluid A. The method of applying the fluid passing between filaments of the fiber bundle is more preferably by a fluid suction mechanism and/or a fluid spraying mechanism. A method of installing a fluid suction mechanism or a fluid spraying mechanism for applying a fluid passing between filaments of the fiber bundle and support rods for supporting the fiber bundle for fiber spreading is particularly preferable.

The fiber spreading method may be any combination of fiber spreading methods. Fiber spreading conditions are not particularly limited. However, it is preferable to control one or more of the air volume during fiber spreading, the width of the air flow, the fiber width before fiber spreading, the tension during transportation, the fiber spreading speed, the fiber spreading time, and the number of fiber spreading steps (number of stages).

Regarding the fiber spreading conditions, from the viewpoint of improving productivity, it is preferable to control the fiber spreading speed, fiber spreading time, and the number of fiber spreading stages (number of stages).

The fiber spreading section of a fiber spreader used for a fiber spreading treatment may be a single fiber spreading section, but the fiber spreader preferably includes a plurality of fiber spreading sections. In an apparatus including a plurality of fiber spreading sections, the respective fiber spreading sections are arranged in series and/or in parallel. Two fiber spreading sections (two stages), three fiber spreading sections (three stages), four fiber spreading sections (four stages), or more fiber spreading sections are provided in series in the apparatus for performing a fiber spreading treatment. In such a continuous-type fiber spreader, for example, the width of the misalignment prevention section may be gradually increased, which makes it possible to gradually spread the fiber bundle. In such a fiber spreader, various modifications, such as changing the fiber spreading conditions by using one of fiber spreading sections or changing the fiber spreading conditions by using two or more fiber spreading sections, can be made for performing fiber spreading.

In the case of multi-stage fiber spreading, suction and blowing may be performed alternately.

In the method of spreading the fiber bundle, the fiber may be loosened in advance and then the fiber spreading treatment may be performed.

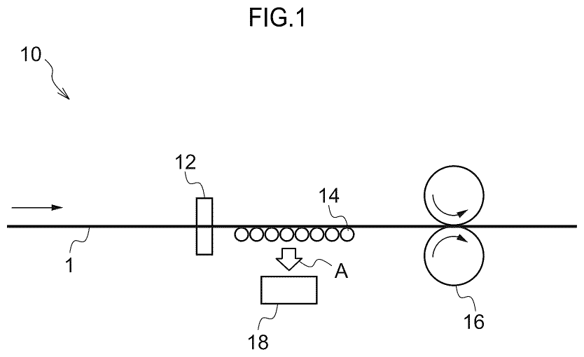

FIG. 1 illustrates an example of one embodiment of a fiber spreader by suction using a fluid that is applicable for spreading a fiber bundle that can be in the production method of the present disclosure.

FIG. 1 is a schematic diagram showing one embodiment of a fiber spreader that can be used in the production method of the present disclosure. A fiber spreader 10 illustrated in FIG. 1 includes a guide 12 as a misalignment prevention section, a support rod 14 for the fiber spreading section, and a conveying roller 16 for conveying the fiber bundle. A fiber bundle 1 guided by the guide 12 is conveyed by the conveying roller 16 in the arrow direction while supported by the support rod 14. The fiber spreading section also includes, as a suction mechanism, a suction device 18 that generates an airflow of a fluid A so as to suck the fiber bundle 1 being conveyed.

The apparatus that is applicable for fiber spreading is not limited thereto. The stabilization treatment refers to performing a heating treatment on a carbon fiber precursor in an oxidizing atmosphere. A carbon fiber precursor that is produced by the above-described production method can be used.

Stabilization of the carbon fiber precursor is carried out at a temperature of preferably from 120° C. to 500° C., more preferably from 150° C. to 480° C., still more preferably from 170° C. to 470° C., particularly preferably from 180° C. to 460° C., and most preferably from 200° C. to 450° C. in an oxidizing atmosphere.

The maximum temperature in the stabilization treatment is not particularly limited. However, from the viewpoints of the improvement of stability during carbonization (thermal decomposition suppression at temperatures during pre-carbonization or carbonization) and the reduction of production costs by shortening the production time, it is preferably 290° C. or higher, more preferably 300° C. or higher, and particularly preferably 330° C. or higher.

Examples of the oxidizing atmosphere during the stabilization treatment include oxidizing atmospheres of oxygen, ozone, air, nitrogen oxides, halogens, sulfurous acid gas, mixtures of these, mixtures of these with inert gases, and the like. Of these, air, a mixed gas of oxygen and air, a mixed gas of oxygen and an inert gas, or a mixed gas of air and an inert gas is preferable, and air is particularly preferable from the viewpoint of cost reduction.

The stabilization treatment time (heating time at the above-described maximum temperature) is not particularly limited, and heating for a long period of time (e.g., more than 4 hours) is possible. However, it is preferably from 1 minute to 4 hours, more preferably from 2 minutes to 2 hours, still more preferably from 3 minutes to 100 minutes, particularly preferably from 4 minutes to 90 minutes, and most preferably from 4 minutes to 60 minutes.

By setting the above-described heating time during the stabilization treatment to the above-described lower limit or more, the carbonization yield can be improved. Meanwhile, by setting the same to the above-described upper limit or less, cost reduction can be achieved.

In the stabilized fiber production step, tension may be applied or may not be applied to the carbon fiber precursor during the course of increasing the temperature up to the above-described stabilization treatment temperature. From the viewpoint of obtaining a sufficient effect by applying tension, it is particularly preferable that tension is applied even during the above-described course of increasing the temperature.

Tension may be applied to the carbon fiber precursor at the early or middle stage of the course of increasing the temperature.

In one embodiment, a stretching treatment is performed at the stabilization treatment temperature, while a stretching treatment is not necessarily performed at other temperatures.

The stretching treatment may be performed while controlling the moisture absorption rate during the spinning treatment or in a step prior to the stabilization treatment.

The tension applied to the carbon fiber precursor during the stretching treatment is preferably from 0.05 mN/tex to 2000 mN/tex, more preferably from 0.1 mN/tex to 500 mN/tex, still more preferably from 0.1 mN/tex to 200 mN/tex, and particularly preferably from 0.2 mN/tex to 100 mN/tex. By setting the tension applied to the carbon fiber precursor during the stretching treatment within the above-described numerical range, the fusion suppression can be improved and breakage and fluff generation in the stabilized fiber can be suppressed.

In the present disclosure, the tension applied to the carbon fiber precursor (unit: mN/tex) is a value obtained by dividing the tension (unit: mN) applied to the carbon fiber precursor during the stabilization treatment by the fineness (unit: tex) of the carbon fiber precursor in an absolute dry state, namely, a tension per unit fineness of the carbon fiber precursor.

The tension can be adjusted by adjusting the speed at the inlet and outlet of a heating apparatus such as a stabilization furnace, or by using a load cell, a spring, a weight, an air cylinder, or the like.

The density of the stabilized fiber obtained via the stabilized fiber production step described above is not particularly limited. However, from the viewpoints of the carbonization yield, productivity, and the like, it is preferably from 1.30 g/cm³ to 1.75 g/cm³, more preferably from 1.35 g/cm³ to 1.70 g/cm³, still more preferably from 1.37 g/cm³ to 1.65 g/cm³, particularly preferably from 1.39 g/cm³ to 1.60 g/cm³, and most preferably from 1.44 g/cm³ to 1.55 g/cm³.

The average fiber diameter of the stabilized fiber is not particularly limited. However, from the viewpoint of the tensile strength of the resulting carbon fiber, it is preferably from 3 nm to 300 μm, more preferably from 30 nm to 150 μm, still more preferably from 1 μm to 60 μm, particularly preferably from 2 μm to 30 μm, and most preferably from 3 μm to 20 μm, or may be from 4 μm to 15 μm. Moreover, by setting the average fiber diameter of the stabilized fiber within the above-described numerical range, breakage and fluff generation in the stabilized fiber can be suppressed.

From the viewpoint of the carbonization yield, the average fiber diameter of the stabilized fiber is smaller than the average fiber diameter of the acrylamide-based polymer fiber serving as a carbon fiber precursor preferably by 5% or more, more preferably by 10% or more, still more preferably by 15% or more, particularly preferably by 20% or more, and most preferably by 25% or more, or may be smaller than the same by 30% or more.

The method of producing a carbon fiber of the present disclosure may further include a step of performing a carbonization treatment on the stabilized acrylamide-based polymer fiber, in addition to the above-described stabilized fiber production step.

In the step of performing a carbonization treatment, it is preferable that the above-described stabilized acrylamide-based polymer fiber has a phosphorus content of from 0.1% by mass to 10% by mass by elemental analysis, the maximum temperature in the above-described step of performing a carbonization treatment is in a range of from 1350° C. to 1650° C., and the carbon fiber fusion rate of the above-described carbonized fiber bundle is preferably 20% or less in one embodiment. The carbon fiber fusion rate of the above-described carbonized fiber bundle is more preferably 15% or less, still more preferably 10% or less, particularly preferably 7% or less, and most preferably 5% or less.

The lower limit of the fusion rate is not particularly limited, and may be, for example, 0%, in a state where carbon fibers are not fused to each other.

The carbonization treatment refers to a treatment of carbonizing a carbon fiber precursor, which means performing a heating treatment in a low-oxygen environment (preferably an oxygen-deprived environment).

Examples of the method of performing a carbonization treatment on the stabilized fiber obtained via the above-described step include a method of performing a heating treatment on the above-described stabilized fiber in an inert atmosphere (in an inert gas such as nitrogen, argon, or helium) at a temperature higher than the temperature during the above-described stabilization treatment (carbonization treatment).

By carrying out the carbonization treatment step, the stabilized fiber is carbonized, thereby obtaining a desired carbon fiber.

During the carbonization treatment, for example, a heating treatment may be performed first at a temperature below 1000° C., and then a heating treatment (carbonization treatment, sometimes referred to as “main carbonization treatment”) may be performed at a temperature of 1000° C. or higher.

In the present disclosure, a heating treatment that is performed first at a temperature below 1000° C. is sometimes referred to as a pre-carbonization treatment, and a heating treatment that is performed at 1000° C. or higher after the pre-carbonization treatment is sometimes referred to as a main carbonization treatment.

It is also possible to perform a heating treatment a plurality of times by, for example, performing a heating treatment at a temperature below 1000° C. (i.e., pre-carbonization treatment) and then performing a heating treatment at 1000° C. or higher (i.e., main carbonization treatment), and further performing a heating treatment at 2000° C. or higher (also referred to as “graphitization treatment”).

The maximum temperature in the above-described main carbonization treatment in the present disclosure is not particularly limited. However, from the viewpoint of easily obtaining the above-described carbon fiber satisfying physical properties in the present disclosure, it is preferably 1300° C. or higher, more preferably 1350° C. or higher, still more preferably 1400° C. or higher, particularly preferably 1450° C. or higher, and most preferably 1500° C. or higher. The maximum temperature during the main carbonization treatment is preferably 1700° C. or lower, more preferably 1675° C. or lower, still more preferably 1650° C. or lower, particularly preferably 1625° C. or lower, and most preferably 1600° C. or lower.

The maximum temperature during heating in the carbonization treatment is particularly preferably in a range of from 1350° C. to 1650° C.

The maximum temperature refers to the maximum temperature in the heating zone measured by a radiation thermometer installed in the heating zone where the carbonization treatment is performed.

As the maximum temperature during heating in the carbonization treatment is in a range of from 1350° C. to 1650° C., preferred contents of phosphorus, nitrogen, and oxygen in the carbon fiber are easily achieved.

In other words, since the maximum temperature is 1350° C. or higher, the nitrogen atom removal property is improved, and the nitrogen content can be easily reduced to 5% by mass or less, and since it is 1650° C. or lower, undesirable decomposition and removal of phosphorus is suppressed, and the phosphorus content can be easily adjusted to a range of from 0.6% by mass to 10% by mass.

The heating temperature during the above-described pre-carbonization treatment is preferably 400° C. or higher, more preferably 500° C. or higher, and further preferably 600° C. or higher.

The “step of performing carbonization treatment” in the present disclosure may include the above-described graphitization treatment that is generally carried out by heating from 2000° C. to 3000° C. in an inert gas atmosphere.

The heating time during carbonization treatment is not particularly limited, but it is preferably from 30 seconds to 120 minutes, more preferably from 30 seconds to 60 minutes, and still more preferably from 1 to 30 minutes. From the viewpoint of reducing the production cost, the upper limit of the heating time is yet still more preferably 20 minutes or less, and particularly preferably 10 minutes or less.

The average fiber diameter of a carbon fiber obtained by the method of producing a carbon fiber of the present disclosure is not particularly limited, but it is preferably from 3 nm to 300 μm, more preferably from 30 nm to 150 μm, still more preferably from 100 nm to 60 μm, yet still more preferably from 1 to 40 μm, particularly preferably from 2 to 30 μm, and most preferably from 2.5 to 25 μm.

Since the average fiber diameter of the carbon fiber is equal to or more than the above-described lower limit, in the case of using a resin or the like as a matrix to prepare a composite material, the decrease in tensile strength of the composite material caused by insufficient impregnation of the resin or the like into the carbon fiber bundle due to the high viscosity of the matrix is suppressed. Since the average fiber diameter is equal to or less than the above-described upper, the decrease in tensile strength of the carbon fiber is suppressed. Accordingly, a carbon fiber having excellent tensile strength can be easily obtained.

The carbon fiber obtained by the method of producing a carbon fiber of the present disclosure can also be used for producing a composite fiber having a coating film containing resin, oil, or the like on the surface of a carbon fiber.

According to the above-described the method of producing a carbon fiber of the present disclosure, it is possible to efficiently produce the carbon fiber of the present disclosure, which has a phosphorus content of from 0.6% by mass to 10% by mass, a nitrogen content of 5% by mass or less, and an oxygen content of 0.3% by mass or less, obtained from elemental analysis, and which has a single filament tensile modulus of 150 GPa or more.

### EXAMPLES

The embodiments described above will be specifically described below with reference to examples, but the embodiments are not limited to these examples. The compositions of the monomers contained in the carbon fiber precursor used in the carbon fiber of the present disclosure are shown below.

Acrylamide-Based Polymer (a-1)

Polymer consisting of 75 mol % of acrylamide (AM) and 25 mol % of acrylonitrile (AN)

Acrylamide-Based Polymer (a-2)

Polymer consisting of 73 mol % of acrylamide (AM), 25 mol % of acrylonitrile (AN), and 2 mol % of acrylic acid (AA)

Acrylamide-Based Polymer (a-3)

Polymer consisting of 65 mol % of acrylamide (AM), 33 mol % of acrylonitrile (AN), and 2 mol % of acrylic acid (AA)

Acrylamide-Based Polymer (a-4)

Polymer consisting of 60 mol % of acrylamide (AM), 35 mol % of acrylonitrile (AN), and 5 mol % of acrylic acid (AA)

### Production Example 1: Production of Acrylamide-Based Polymer Fiber (f-1)

Dry spinning was performed using an aqueous solution obtained by dissolving the above-described acrylamide-based polymer (a-1) in ion-exchanged water and adding 3 parts by mass of phosphoric acid with respect to 100 parts by mass of (a-1) such that the single filament fineness of the acrylamide-based polymer fiber resulted in 5 dtex, thereby preparing a fiber bundle consisting of an acrylamide-based polymer fiber (f-1) at 100 filaments/bundle.

The fineness and average fiber diameter of single filaments constituting the obtained fiber bundle of the acrylamide-based polymer fiber (f-1) were determined by the following methods. The fineness was 5.2 dtex/fiber and the average fiber diameter was 23 μm.

### Production Example 2: Production of Acrylamide-Based Polymer Fiber (f-2)

Dry spinning was performed using an aqueous solution obtained by dissolving the above-described acrylamide-based polymer (a-2) in ion-exchanged water and adding 3 parts by mass of phosphoric acid with respect to 100 parts by mass of (a-2) such that the single filament fineness of an acrylamide-based polymer fiber resulted in 7 dtex, thereby preparing a bundle of an acrylamide-based polymer fiber (f-2) at 100 filaments/bundle.

The fineness and average fiber diameter of the acrylamide-based polymer fiber (f-2) were determined by the following methods. The fineness was 6.8 dtex/fiber and the average fiber diameter was 26 μm.

### Production Example 3: Production of Acrylamide-Based Polymer Fiber (f-3)

Dry spinning was performed using an aqueous solution obtained by dissolving the above-described acrylamide-based polymer (a-3) in ion-exchanged water and adding and dissolving 3 parts by mass of diammonium hydrogen phosphate as a salt of phosphoric acid (phosphate) with respect to 100 parts by mass of (a-3) such that the single filament fineness of an acrylamide-based polymer fiber resulted in 2 dtex, thereby preparing a bundle of an acrylamide-based polymer fiber (f-3) at 100 filaments/bundle. The fineness and average fiber diameter of the acrylamide-based polymer fiber (f-3) were determined by the following methods. The fineness was 2.0 dtex/fiber and the average fiber diameter was 14 μm.

### Production Example 4: Production of Acrylamide-Based Polymer Fiber (f-4)

Dry spinning was performed using an aqueous solution obtained by dissolving the above-described acrylamide-based polymer (a-3) in ion-exchanged water and adding 3 parts by mass of phosphoric acid with respect to 100 parts by mass of (a-3) such that the single filament fineness of an acrylamide-based polymer fiber resulted in 2 dtex, thereby preparing a bundle of an acrylamide-based polymer fiber (f-4) at 100 filaments/bundle.

The fineness and average fiber diameter of the obtained acrylamide-based polymer fiber (f-4) were determined by the following methods. The fineness was 2.3 dtex/fiber and the average fiber diameter was 15 μm.

### Production Example 5: Production of Acrylamide-Based Polymer Fiber (f-5)

Dry spinning was performed using an aqueous solution obtained by dissolving the above-described acrylamide-based polymer (a-4) in ion-exchanged water and adding 3 parts by mass of phosphoric acid with respect to 100 parts by mass of the acrylamide-based polymer (a-4) such that the single filament fineness of an acrylamide-based polymer fiber resulted in 4 dtex, thereby preparing a bundle of an acrylamide-based polymer fiber (f-5) at 100 filaments/bundle.

The fineness and average fiber diameter of single filaments constituting the obtained fiber bundle of the acrylamide-based polymer fiber (f-5) were determined by the following methods. The fineness was 3.9 dtex/fiber and the average fiber diameter was 20 μm.

### Production Example 6: Production of Acrylamide-Based Polymer Fiber (f-6) (No Phosphorus-Based Catalyst Added)

Dry spinning was performed using an aqueous solution obtained by dissolving the above-described acrylamide-based polymer (a-1) in ion-exchanged water such that the single filament fineness of an acrylamide-based polymer fiber resulted in 5 dtex, thereby preparing a fiber bundle consisting of an acrylamide-based polymer fiber (f-6) at 100 filaments/bundle. The fineness and average fiber diameter of single filaments constituting the fiber bundle of the acrylamide-based polymer fiber (f-6) were determined by the following methods. The fineness was 5.0 dtex/fiber and the average fiber diameter was 23 μm.

### <Fineness of Acrylamide-Based Polymer Fiber>

The obtained fiber bundle of the acrylamide-based polymer fiber (100 filaments/bundle) was dried at 120° C. for 2 hours. The mass was then measured for calculating the fineness of the above-described fiber bundle by the following Formula (1), thereby determining the fineness of single filaments constituting the fiber bundle (fineness of the above-described acrylamide-based polymer fiber).

$$Fineness of fiber bundle [ dtex ] = ( Mass of fiber bundle [ g ] / fiber length [ m ] ) \times 10000 [ m ] \qquad Formula ( 1 )$$

### <Average Fiber Diameter of Acrylamide-Based Polymer Fiber>

The density of each acrylamide-based polymer fiber bundle after vacuum drying at 120° C. for 1 hour was measured using a dry automatic density meter (“AccuPyc II1340” manufactured by Micromeritics Corporation). The average fiber diameter of single filaments constituting the above-described fiber bundle (average fiber diameter of the above-described acrylamide-based polymer fiber) was determined by the following Formula (2).

$$D = \{ ( Dt \times 4 \times 100 ) / ( ρ \times π \times n ) \} 1 / 2 \qquad Formula ( 2 )$$

(In Formula (2), D represents the average fiber diameter [μm] of single filaments constituting a fiber bundle, Dt represents the fineness [dtex] of the fiber bundle, p represents the density [g/cm³] of the fiber bundle, and n represents the number of single filaments [filaments] constituting the fiber bundle.)
<Preparation of Stabilized Fiber (s-1) by Stabilizing Acrylamide-Based Polymer Fiber (f-1)>

A fiber bundle (800 filaments/bundle; fiber bundle width: 4.5 mm) was obtained by applying 2 parts by mass of a silicone-based oil agent (KF-96H-100cs manufactured by Shin-Etsu Chemical Co., Ltd.; kinematic viscosity at 25° C.: 100 mm²/s) to 100 parts by mass of a fiber bundle (100 filaments/bundle) of the acrylamide-based polymer fiber (f-1) (average fiber diameter: 23 μm) and combining 8 bundles of the same. This fiber bundle was fed onto support rods of a fiber spreader (FIG. 1) at a conveying speed of 150 mm/min and spread by air suction using air as a fluid (airflow width: 25 mm×22 mm (fiber bundle length in the fiber axis direction)), thereby obtaining a spread fiber bundle having a fiber bundle width of 20 mm.

The width of this spread fiber bundle was further increased, thereby obtaining a spread fiber bundle in which the individual single filaments constituting the fiber bundle were arranged such that they were substantially not in contact with each other (fiber width after fiber spreading: 50 mm; ratio of fiber width of spread fiber bundle to width of original fiber bundle (fiber spreading ratio): 11.1 times). Next, this spread fiber bundle was heat-treated (stabilized) in a heating treatment apparatus by increasing the temperature from room temperature to 350° C. over 30 minutes under air flow while stretching at a stretching ratio of 6 times, and the fiber bundle was then kept at 350° C. for 30 minutes for stabilization, thereby obtaining a stabilized fiber (s-1) (800 filaments/bundle; average fiber diameter of single filaments: 8 μm).

<Preparation of Stabilized Fiber (s-2) by Stabilizing Acrylamide-Based Polymer Fiber (f-2)>

A fiber bundle (800 filaments/bundle; fiber bundle width: 4.5 mm) was obtained by applying 2 parts by mass of a silicone-based oil agent (KF-96H-100cs manufactured by Shin-Etsu Chemical Co., Ltd.) to 100 parts by mass of a fiber bundle (100 filaments/bundle) of the acrylamide-based polymer fiber (f-2) (average fiber diameter: 26 μm) and combining 8 bundles of the same. This fiber bundle was fed onto support rods of a fiber spreader (FIG. 1) at a conveying speed of 150 mm/min and spread by air suction using air as a fluid (airflow width: 25 mm×22 mm (fiber bundle length in the fiber axis direction)), thereby obtaining a spread fiber bundle having a fiber bundle width of 20 mm. The width of this spread fiber bundle was further increased, thereby obtaining a spread fiber bundle in which the individual single filaments constituting the fiber bundle were arranged such that they were substantially not in contact with each other (fiber bundle width after fiber spreading: 50 mm; fiber spreading ratio: 12.5 times).

Next, the temperature was increased from room temperature to 350° C. over 30 minutes under air flow while stretching the fiber bundle at a stretching ratio of 4 times, and the fiber bundle was then kept at 350° C. for 30 minutes for stabilizing, thereby obtaining a stabilized fiber (s-2) (800 filaments/bundle; average fiber diameter of single filaments: 8 μm).

<Preparation of Stabilized Fiber (s-3) by Stabilizing Acrylamide-Based Polymer Fiber (f-3)>

A fiber bundle (800 filaments/bundle; fiber bundle width: 3 mm) was obtained by applying 2 parts by mass of a silicone-based oil agent (KF-96H-100cs manufactured by Shin-Etsu Chemical Co., Ltd.) to 100 parts by mass of a fiber bundle (100 filaments/bundle) of the acrylamide-based polymer fiber (f-3) (average fiber diameter: 14 μm) and combining 8 bundles of the same. This fiber bundle was fed onto support rods of a fiber spreader (FIG. 1) at a conveying speed of 150 mm/min and spread by air suction using air as a fluid (airflow width: 25 mm×22 mm (fiber bundle length in the fiber axis direction)), thereby obtaining a spread fiber bundle having a fiber bundle width of 20 mm. The width of this spread fiber bundle was further increased, thereby obtaining a spread fiber bundle in which the individual single filaments constituting the fiber bundle were arranged such that they were substantially not in contact with each other (fiber width after fiber spreading: 50 mm; fiber spreading ratio: 16.7 times). Next, the temperature was increased from room temperature to 350° C. over 30 minutes under air flow while stretching this fiber bundle at a stretching ratio of 4 times, and the fiber bundle was then kept at 350° C. for 30 minutes for stabilizing, thereby obtaining a stabilized fiber (s-3) (800 filaments/bundle; average fiber diameter of single filaments: 6 μm).

<Preparation of Stabilized Fiber (s-4) by Stabilizing Acrylamide-Based Polymer Fiber (f-4)>

A fiber bundle (800 filaments/bundle; fiber bundle width: 3 mm) was obtained by applying 2 parts by mass of a silicone-based oil agent (KF-96H-100cs manufactured by Shin-Etsu Chemical Co., Ltd.) to 100 parts by mass of a fiber bundle (100 filaments/bundle) of the acrylamide-based polymer fiber (f-4) (average fiber diameter: 15 μm) and combining 8 bundles of the same.

This fiber bundle was fed onto support rods of a fiber spreader (FIG. 1) at a conveying speed of 150 mm/min and spread by air suction using air as a fluid (airflow width: 25 mm×22 mm (fiber bundle length in the fiber axis direction)), thereby obtaining a spread fiber bundle having a fiber bundle width of 20 mm.

The width of this spread fiber bundle was further increased, thereby obtaining a spread fiber bundle in which the individual single filaments constituting the fiber bundle were arranged such that they were substantially not in contact with each other (fiber width after fiber spreading: 50 mm; fiber spreading ratio: 16.7 times). Next, the temperature was increased from room temperature to 350° C. over 30 minutes under air flow while stretching this fiber bundle at a stretching ratio of 4 times, and the fiber bundle was then kept at 350° C. for 30 minutes for stabilizing, thereby obtaining a stabilized fiber (s-4) (800 filaments/bundle; average fiber diameter of single filaments: 6 μm).

<Preparation of Stabilized Fiber (s-5) by Stabilizing Acrylamide-Based Polymer Fiber (f-5)>

A fiber bundle (800 filaments/bundle; fiber bundle width: 4 mm) was obtained by applying 2 parts by mass of a silicone-based oil agent (KF-96H-100cs manufactured by Shin-Etsu Chemical Co., Ltd.) to 100 parts by mass of a fiber bundle (100 filaments/bundle) of the acrylamide-based polymer fiber (f-5) (average fiber diameter: 20 μm) and combining 8 bundles of the same. This fiber bundle was fed onto support rods of a fiber spreader (FIG. 1) at a conveying speed of 150 mm/min and spread by air suction using air as a fluid (airflow width: 25 mm×22 mm (fiber bundle length in the fiber axis direction)), thereby obtaining a spread fiber bundle having a fiber bundle width of 20 mm. The width of this spread fiber bundle was further increased, thereby obtaining a spread fiber bundle (fiber width after fiber spreading: 50 mm). Next, the temperature was increased from room temperature to 350° C. over 30 minutes under air flow while stretching this fiber bundle at a stretching ratio of 6 times, and the fiber bundle was then kept at 350° C. for 30 minutes for stabilizing, thereby obtaining a stabilized fiber (s-5) (800 filaments/bundle; average fiber diameter of single filaments: 9 μm).

<Preparation of Stabilized Fiber (s-6) by Stabilizing Acrylamide-Based Polymer Fiber (f-1): No Fiber Spreading Step>

A fiber bundle (800 filaments/bundle; fiber bundle width: 4.5 mm) was obtained by applying 2 parts by mass of a silicone-based oil agent (KF-96H-100cs manufactured by Shin-Etsu Chemical Co., Ltd.; kinematic viscosity at 25° C.: 30 mm²/s) to 100 parts by mass of a fiber bundle (100 filaments/bundle) of the acrylamide-based polymer fiber (f-1) (average fiber diameter: 23 μm) and combining 8 bundles of the same. Next, the temperature was increased from room temperature to 350° C. over 30 minutes under air flow while stretching this fiber bundle at a stretching ratio of 6 times, and the fiber bundle was then kept at 350° C. for 30 minutes for stabilizing, thereby obtaining a stabilized fiber (s-6) (800 filaments/bundle; average fiber diameter of single filaments: 8 μm). The fusion rate of the stabilized fiber was 75%.

<Preparation of Stabilized Fiber (s-7) by Stabilizing Acrylamide-Based Polymer Fiber (f-6) (No Phosphorus-Based Compound Added)>

A fiber bundle (800 filaments/bundle; fiber bundle width: 4.5 mm) was obtained by applying 2 parts by mass of a silicone-based oil agent (KF-96H-100cs manufactured by Shin-Etsu Chemical Co., Ltd.; kinematic viscosity at 25° C.: 30 mm²/s) to 100 parts by mass of a fiber bundle (100 filaments/bundle) of the acrylamide-based polymer fiber (f-6) (average fiber diameter: 23 μm) and combining 8 bundles of the same. Next, the temperature was increased from room temperature to 350° C. over 30 minutes under air flow while stretching this fiber bundle at a stretching ratio of 6 times, and the fiber bundle was then kept at 350° C. for 30 minutes for stabilization, thereby obtaining a stabilized fiber (s-7) (800 filaments/bundle; average fiber diameter of single filaments: 8 μm). The fusion rate of the stabilized fiber was 80%.

### [Preparation of Carbon Fibers]

### Example 1

A plurality of the stabilized fiber (s-1) (800 filaments/bundle) was bundled to result in 12,000 filaments/bundle. While undergoing a tension of 70 cN, the bundle was transferred in a heating treatment furnace with a temperature gradient of from 300° C. to 800° C. under a nitrogen stream over 3 minutes for performing a pre-carbonization treatment (3 minutes), thereby preparing a pre-carbonized fiber.

Next, while undergoing a tension of 70 cN, the pre-carbonized fiber was transferred in a heating treatment furnace having a heating zone with a temperature gradient of from 1050° C. to 1350° C. (maximum temperature in the heating zone measured by a radiation thermometer: 1350° C.) under a nitrogen stream over 3 minutes for performing a heating treatment (carbonization treatment). The fiber was wound around a paper tube (inner diameter: 76.5 mm; thickness: 3 mm; length: 280 mm) while undergoing a tension of 200 gf, thereby obtaining a carbon fiber (average fiber diameter: 5 μm).

The maximum temperature in the heating treatment furnace, 1350° C., is the maximum temperature measured by a radiation thermometer in the heating treatment furnace.

In the following Examples, the maximum temperature in a heating treatment furnace refers to the upper limit of the set temperatures, namely, the maximum temperature measured with a radiation thermometer in the heating treatment furnace. The maximum temperatures for the heating treatment are listed in Table 1 below.

### Example 2

A plurality of the stabilized fiber (s-5) (800 filaments/bundle) was bundled to result in 12,000 filaments/bundle. While undergoing a tension of 70 cN, the bundle was transferred in a heating treatment furnace with a temperature gradient of from 300° C. to 800° C. under a nitrogen stream over 3 minutes for performing a pre-carbonization treatment (3 minutes), thereby preparing a pre-carbonized fiber.

Next, while undergoing a tension of 70 cN, the pre-carbonized fiber was transferred in a heating treatment furnace having a heating zone with a temperature gradient of from 1100° C. to 1400° C. (maximum temperature in the heating zone measured by a radiation thermometer: 1350° C.) under a nitrogen stream over 3 minutes for performing a heating treatment (carbonization treatment). The fiber was wound around a paper tube (inner diameter: 76.5 mm; thickness: 3 mm; length: 280 mm) while undergoing a tension of 200 gf, thereby obtaining a carbon fiber (average fiber diameter: 5 μm).

### Example 3

A plurality of the stabilized fiber (s-5) (800 filaments/bundle) was bundled to result in 12,000 filaments/bundle. While undergoing a tension of 70 cN, the bundle was transferred in a heat treatment furnace with a temperature gradient of from 300° C. to 800° C. under a nitrogen stream over 3 minutes for performing pre-carbonization treatment (3 minutes), thereby preparing a pre-carbonized fiber.

Next, while undergoing a tension of 70 cN, the pre-carbonized fiber was transferred in a heating treatment furnace with a temperature gradient of from 1200° C. to 1500° C. under a nitrogen stream over 3 minutes for performing a heating treatment (carbonization treatment). The fiber was wound around a paper tube (inner diameter: 76.5 mm; thickness: 3 mm; length: 280 mm) while undergoing a tension of 200 gf, thereby obtaining a carbon fiber (average fiber diameter: 5 μm).

### Example 4

A plurality of the stabilized fiber (s-3) (800 filaments/bundle) was bundled to result in 12,000 filaments/bundle. While undergoing a tension of 70 cN, the bundle was transferred in a heating treatment furnace with a temperature gradient of from 300° C. to 800° C. under a nitrogen stream over 3 minutes for performing a pre-carbonization treatment (3 minutes), thereby preparing a pre-carbonized fiber.

Next, while undergoing a tension of 70 cN, the pre-carbonized fiber was transferred in a heating treatment furnace with a temperature gradient of from 1300° C. to 1600° C. under a nitrogen stream over 3 minutes for performing a heating treatment (carbonization treatment). The fiber was wound around a paper tube (inner diameter: 76.5 mm; thickness: 3 mm; length: 280 mm) while undergoing a tension of 200 gf, thereby obtaining a carbon fiber (average fiber diameter: 4 μm).

### Example 5

A plurality of the stabilized fiber (s-4) (800 filaments/bundle) was bundled to result in 12,000 filaments/bundle. While undergoing a tension of 70 cN, the bundle was transferred in a heating treatment furnace with a temperature gradient of from 300° C. to 800° C. under a nitrogen stream over 3 minutes for performing a pre-carbonization treatment (3 minutes), thereby preparing a pre-carbonized fiber.

Next, while undergoing a tension of 70 cN, the pre-carbonized fiber was transferred in a heating treatment furnace with a temperature gradient of from 1300° C. to 1600° C. under a nitrogen stream over 3 minutes for performing a heating treatment (carbonization treatment). The fiber was wound around a paper tube (inner diameter: 76.5 mm; thickness: 3 mm; length: 280 mm) while undergoing a tension of 200 gf, thereby obtaining a carbon fiber (average fiber diameter: 4 μm).

### Example 6

A plurality of the stabilized fiber (s-4) (800 filaments/bundle) was bundled to result in 12,000 filaments/bundle. While undergoing a tension of 70 cN, the bundle was transferred in a heating treatment furnace with a temperature gradient of from 300° C. to 800° C. under a nitrogen stream over 3 minutes for performing a pre-carbonization treatment (3 minutes), thereby preparing a pre-carbonized fiber.

Next, while undergoing a tension of 70 cN, the pre-carbonized fiber was transferred in a heating treatment furnace with a temperature gradient of from 1400° C. to 1700° C. under a nitrogen stream over 3 minutes for performing a heating treatment (carbonization treatment). The fiber was wound around a paper tube (inner diameter: 76.5 mm; thickness: 3 mm; length: 280 mm) while undergoing a tension of 200 gf, thereby obtaining a carbon fiber (average fiber diameter: 4 μm).

### Example 7

A plurality of the stabilized fiber (s-2) (800 filaments/bundle) was bundled to result in 12,000 filaments/bundle. While undergoing a tension of 70 cN, the bundle was transferred in a heating treatment furnace with a temperature gradient of from 300° C. to 800° C. under a nitrogen stream over 3 minutes for performing a pre-carbonization treatment (3 minutes), thereby preparing a pre-carbonized fiber.

Next, while undergoing a tension of 70 cN, the pre-carbonized fiber was transferred in a heating treatment furnace with a temperature gradient of from 1400° C. to 1700° C. under a nitrogen stream over 3 minutes for performing a heating treatment (carbonization treatment). The fiber was wound around a paper tube (inner diameter: 76.5 mm; thickness: 3 mm; length: 280 mm) while undergoing a tension of 200 gf, thereby obtaining a carbon fiber (average fiber diameter: 6 μm).

### Comparative Example 1

A plurality of the stabilized fiber (s-1) (800 filaments/bundle) was bundled to result in 12,000 filaments/bundle. While undergoing a tension of 70 cN, the bundle was transferred in a heating treatment furnace with a temperature gradient of from 300° C. to 800° C. under a nitrogen stream over 3 minutes for performing a pre-carbonization treatment (3 minutes), thereby preparing a pre-carbonized fiber.

Next, while undergoing a tension of 70 cN, the pre-carbonized fiber was transferred in a heating treatment furnace set to 1000° C. under a nitrogen stream over 3 minutes for performing a heating treatment (carbonization treatment). The fiber was wound around a paper tube (inner diameter: 76.5 mm; thickness: 3 mm; length: 280 mm) while undergoing a tension of 200 gf, thereby obtaining a carbon fiber (average fiber diameter: 6 μm).

### Comparative Example 2

A plurality of the stabilized fiber (s-2) (800 filaments/bundle) was bundled to result in 12,000 filaments/bundle. While undergoing a tension of 70 cN, the bundle was transferred in a heating treatment furnace with a temperature gradient of from 300° C. to 800° C. under a nitrogen stream over 3 minutes for performing a pre-carbonization treatment (3 minutes), thereby preparing a pre-carbonized fiber.

Next, while undergoing a tension of 70 cN, the pre-carbonized fiber was transferred in a heating treatment furnace with a temperature gradient of from 1500° C. to 1800° C. under a nitrogen stream over 3 minutes for performing a heating treatment (carbonization treatment). The fiber was wound around a paper tube (inner diameter: 76.5 mm; thickness: 3 mm; length: 280 mm) while undergoing a tension of 200 gf, thereby obtaining a carbon fiber (average fiber diameter: 6 μm).

### Comparative Example 3

A plurality of the stabilized fiber (s-4) (800 filaments/bundle) was bundled to result in 12,000 filaments/bundle. While undergoing a tension of 70 cN, the bundle was transferred in a heating treatment furnace with a temperature gradient of from 300° C. to 800° C. under a nitrogen stream over 3 minutes for performing a pre-carbonization treatment (3 minutes), thereby preparing a pre-carbonized fiber.

Next, while undergoing a tension of 70 cN, the pre-carbonized fiber was transferred in a heating treatment furnace with a temperature gradient of from 1500° C. to 1800° C. under a nitrogen stream over 3 minutes for performing a heating treatment (carbonization treatment). The fiber was wound around a paper tube (inner diameter: 76.5 mm; thickness: 3 mm; length: 280 mm) while undergoing a tension of 200 gf, thereby obtaining a carbon fiber (average fiber diameter: 4 μm).

### Comparative Example 4

A plurality of the stabilized fiber (s-6) (800 filaments/bundle) was bundled to result in 12,000 filaments/bundle. While undergoing a tension of 70 cN, the bundle was transferred in a heating treatment furnace with a temperature gradient of from 300° C. to 800° C. under a nitrogen stream over 3 minutes for performing a pre-carbonization treatment (3 minutes), thereby preparing a pre-carbonized fiber.

Next, while undergoing a tension of 70 cN, the pre-carbonized fiber was transferred in a heating treatment furnace set to 1350° C. under a nitrogen stream over 3 minutes for performing a heating treatment (carbonization treatment). The fiber was wound around a paper tube (inner diameter: 76.5 mm; thickness: 3 mm; length: 280 mm) while undergoing a tension of 200 gf, thereby obtaining a carbon fiber (average fiber diameter: 5 μm).

### Comparative Example 5

A plurality of the stabilized fiber (s-7) (800 filaments/bundle) was bundled to result in 12,000 filaments/bundle. While undergoing a tension of 70 cN, the bundle was transferred in a heating treatment furnace with a temperature gradient of from 300° C. to 800° C. under a nitrogen stream over 3 minutes for performing a pre-carbonization treatment (3 minutes), thereby preparing a pre-carbonized fiber.

Next, while undergoing a tension of 70 cN, the pre-carbonized fiber was transferred in a heating treatment furnace set to 1350° C. under a nitrogen stream over 3 minutes for performing a heating treatment (carbonization treatment). The fiber was wound around a paper tube (inner diameter: 76.5 mm; thickness: 3 mm; length: 280 mm) while undergoing a tension of 200 gf, thereby obtaining a carbon fiber (average fiber diameter: 5 μm).

### Reference Example 1

A polyacrylonitrile-based fiber (number of filaments: 3000 filaments/bundle; fiber bundle fineness: 360 tex/bundle; single filament fineness: 0.12 tex/fiber; single filament diameter: about 11 μm) was prepared as a raw material fiber.

The raw material fiber was transferred under an air flow in a heating furnace with a temperature gradient (temperature increase) of from 200° C. to 300° C. for 60 minutes (stabilized fiber production step). Thus, a stabilized fiber (number of filaments: 3000 filaments/bundle; fiber bundle fineness: 330 tex/bundle; single filament fineness: 0.11 tex/fiber; single filament diameter: about 10 μm) was prepared.

This stabilized fiber was transferred in a heating furnace with a temperature gradient of from 300° C. to 800° C. (maximum temperature: 800° C.) under a nitrogen stream over 3 minutes (pre-carbonization treatment step). In this way, a bundle of a pre-carbonized fiber (number of filaments: 3000 filaments/bundle; fiber bundle fineness: 180 tex/bundle; single filament fineness: 0.06 tex/fiber; single filament diameter: about 7 μm) was prepared. While undergoing a tension of 70 cN, the pre-carbonized fiber was transferred in a heating treatment furnace with a temperature gradient of from 1100° C. to 1400° C. under a nitrogen stream over 3 minutes for performing a heating treatment (carbonization treatment). The fiber was wound around a paper tube (inner diameter: 76.5 mm; thickness: 3 mm; length: 280 mm) while undergoing a tension of 200 gf, thereby obtaining a polyacrylonitrile-based carbon fiber (average fiber diameter: 7 μm).

### Reference Example 2

A fiber was prepared in the same method as in Reference Example 1 except that there was a change to a heating treatment furnace with a temperature gradient of from 1200° C. to 1500° C. (maximum temperature in the heating zone measured with a radiation thermometer: 1500° C.) in terms of carbonization treatment temperature. The fiber was wound around a paper tube (inner diameter: 76.5 mm; thickness: 3 mm; length: 280 mm) while undergoing a tension of 200 gf, thereby obtaining a polyacrylonitrile-based carbon fiber (average fiber diameter: 7 μm).

### Reference Example 3

Commercially available polyacrylonitrile-based carbon fiber (c-1): 12000 filaments/bundle; fineness: 800 tex; density: 1.76 g/cm³; average fiber diameter: 7 μm

### Reference Example 4

Commercially available polyacrylonitrile-based carbon fiber (c-2): 12000 filaments/bundle; fineness: 800 tex; density: 1.8 g/cm³; average fiber diameter: 7 μm

### <Evaluation of Fusion Rate>

A fiber bundle for evaluation having a length of 3 cm was cut out from each of the stabilized fibers and carbon fibers in the above-described Examples, Comparative Examples, and Reference Examples. The fiber bundle was based on 800 filaments.

The cross-section of each fiber bundle for evaluation was observed using a microscope (“Digital Microscope VHX-7000” manufactured by KEYENCE CORPORATION), and the number of filaments was counted.

At this time, the number of fused filaments and the number of all filaments constituting each fiber bundle for evaluation were counted. The number of fused filaments was counted as two when, for example, two fibers were fused to each other. The total number of filaments was counted by separating the fused filaments into their pre-fused state. The fusion rate was calculated based on the following Formula (3). The calculated results are shown in Table 1 as “Fusion rate”.

$$Fusion rate ( \% ) = ( Number of fused filaments / Total number of filaments ) \times 100 \qquad Formula ( 3 )$$

### <Fineness of Stabilized Fiber>

The mass of the obtained stabilized fiber was measured when completely dried or after drying at 120° C. for 2 hours, and the fineness of the fiber bundle was calculated according to the following formula (1), thereby obtaining the fineness of single filaments constituting the above-described stabilized fiber (fineness of the above-described stabilized fiber).

$$Fineness of fiber bundle [ dtex ] = ( Mass of fiber bundle [ g ] / fiber length [ m ] ) \times 10000 [ m ] \qquad Formula ( 1 )$$

### <Average Fiber Diameter of Stabilized Fiber>

Each side surface of the stabilized fiber was observed using a microscope (“Digital Microscope VHX-1000” manufactured by KEYENCE CORPORATION). The fiber diameter measurement point of each of 10 randomly sampled single filaments was randomly selected, and the fiber diameter of each of the single filaments constituting the above-described stabilized fiber was measured. The average value (average fiber diameter of the stabilized fiber) was calculated.

### <Average Fiber Diameter of Carbon Fiber>

Each side surface of the carbon fiber was observed using a microscope (“Digital Microscope VHX-1000” manufactured by KEYENCE CORPORATION). The fiber diameter measurement point of each of 10 randomly sampled single filaments was randomly selected, and the fiber diameter of each of the single filaments constituting the above-described carbon fiber was measured. The average value (average fiber diameter of the carbon fiber) was calculated.

### <Quantitative Determination of Carbon (C) and Nitrogen (N) Elements in Carbon Fiber>

The carbon fiber was dried at 120° C. for 1 hour under atmospheric pressure and then analyzed by the following method.
Analysis method: Oxygen circulation combustion/thermal conductivity detector (TCD) detection method
Apparatus: SUMIGRAPH NCH-22F (manufactured by Sumika Chemical Analysis Service, Ltd.)

Each sample was decomposed and completely oxidized by burning it for 15 minutes while circulating O₂ gas using a gas chromatograph equipped with a TCD. The carbon component was converted into CO₂ and the nitrogen component was converted into N₂ gas, and then detected and quantitatively determined.

### <Quantitative Determination of Oxygen (O) Element in Carbon Fiber>

The carbon fiber was dried at 120° C. for 1 hour under atmospheric pressure and then analyzed by the following method.
Analysis method: Impulse heating and melting in an inert gas-non-dispersive infrared absorption (NDIR) detection method
Apparatus: EMGA-920 (manufactured by HORIBA, Ltd.)

A sample was placed in a graphite crucible, and a current was passed through the graphite crucible in He gas (oxygen-free), thereby melting the sample at about 2500° C. The oxygen component was converted into CO gas and then detected and quantitatively determined.

### <Quantitative Determination of Phosphorus (P) Element in Carbon Fiber>

The carbon fiber was dried at 120° C. for 1 hour under atmospheric pressure and then analyzed by the following method.
Analysis method: Ashing/acid dissolution/inductively coupled plasma mass spectrometry (ICP-MS) method
Apparatus: NexION 2000C (manufactured by PerkinElmer)

The carbon fiber was heated and incinerated, and the solution obtained by dissolving it with an acid was subjected to quantitative determination of phosphorus using ICP-MS (ion source: argon gas plasma).

<Prevention of Generation of Fluff during Unwinding of Carbon Fiber>

The obtained carbon fiber (length of carbon fiber wound on the paper tube: about 10 m) on the paper tube (inner diameter: 76.5 mm; thickness: 3 mm; length: 280 mm) was unwound and released from the paper tube at a speed of 0.3 m/min while undergoing a tension of 70 cN, thereby cutting out a fiber bundle (length: 5 cm) for evaluation. Each fiber bundle for evaluation was visually and microscopically observed using a microscope (“Digital Microscope VHX-7000” manufactured by KEYENCE CORPORATION) for the presence or absence of fluff in the carbon fiber caused by breaking due to catching on or friction with other carbon fibers or the like during unwinding. The evaluation was performed according to the following criteria. In the evaluation criteria, ranks A and B are levels that pose no practical problems.

### Evaluation Criteria

A: There is no fluff caused by breaking of the fiber when unwound.
B: There is one fluff caused by breaking of the fiber when unwound.
C: There are two or more fluffs caused by breaking of the fiber when unwound.

### <Average Fiber Diameter of Carbon Fiber>

Each side surface of the obtained carbon fiber was observed using a microscope (“Digital Microscope VHX-1000” manufactured by KEYENCE CORPORATION). The fiber diameter measurement point of each of 10 randomly sampled single filaments was randomly selected, and the fiber diameter of each of the single filaments constituting the above-described carbon fiber was measured. The average value (average fiber diameter of the carbon fiber) was calculated.

### <Tensile Modulus and Tensile Strength of Single Filament of Carbon Fiber>

Five single filaments were taken out from the obtained carbon fiber. A tensile test (gauge length: 25 mm; tensile speed: 1 mm/min) was conducted on each single filament at room temperature (25° C.) in accordance with JIS R7606:2000 using a micro strength evaluation testing machine (Micro Autograph MST-I, manufactured by SHIMADZU CORPORATION). The tensile modulus and tensile strength were measured. The measurements were carried out using five samples, and the average values were taken as the tensile modulus and tensile strength. The results are shown in Table 1.

The precursor (polymer composition), production conditions, content of each element, and evaluation results (fusion rate of carbon fiber, suppression of fluff generation during unwinding of carbon fiber, tensile modulus of single filament of carbon fiber, and tensile strength of single filament) of each carbon fiber described above are shown in Table 1 below. In the evaluation item names in Table 1 below, the tensile modulus of a single filament of the carbon fiber is described as “tensile modulus”, and the tensile strength of a single filament of the carbon fiber is described as “tensile strength”.

Regarding the content of an element, “0.0” encompasses not only the absence of the atom of interest, but also the presence of the atom below the detection limit by the above-described elemental analysis.

In the evaluation items, “-” indicates that evaluation was not possible.

TABLE 1

| | | | | | | Maximum | |
|---|---|---|---|---|---|---|---|
| | Precursor | | Phosphorus- | | | carbonization | |
| | (polymer | Precursor | based | Fiber | Stabilized | temperature | Element content (% by mass) |
| | composition) | fiber | compound | spreading | fiber | (° C.) | P |
| Example | (a-1) | (f-1) | Phosphoric | Performed | (s-1) | 1350 | 1.7 |
| 1 | (AM/AN = | | acid | | | | |
| | 75/25) | | | | | | |
| Example | (a-4) | (f-5) | Phosphoric | Performed | (s-5) | 1400 | 1.6 |
| 2 | (AM/AN/AA = | | acid | | | | |
| | 60:35/5) | | | | | | |
| Example | (a-4) | (f-5) | Phosphoric | Performed | (s-5) | 1500 | 1.4 |
| 3 | (AM/AN/AA = | | acid | | | | |
| | 60:35/5) | | | | | | |
| Example | (a-3) | (f-3) | Phosphate | Performed | (s-3) | 1600 | 1.1 |
| 4 | (AM/AN/AA = | | | | | | |
| | 65:33/2) | | | | | | |
| Example | (a-3) | (f-4) | Phosphoric | Performed | (s-4) | 1600 | 1.2 |
| 5 | (AM/AN/AA = | | acid | | | | |
| | 65/33/2) | | | | | | |
| Example | (a-3) | (f-4) | Phosphoric | Performed | (s-4) | 1700 | 0.7 |
| 6 | (AM/AN/AA = | | acid | | | | |
| | 65/33/2) | | | | | | |
| Example | (a-2) | (f-2) | Phosphoric | Performed | (s-2) | 1700 | 0 8 |
| 7 | (AM/AN/AA = | | acid | | | | |
| | 73/25/2) | | | | | | |
| Comparative | (a-1) | (f-1) | Phosphoric | Performed | (s-1) | 1000 | 1.6 |
| Example 1 | (AM/AN = | | acid | | | | |
| | 75/25) | | | | | | |
| Comparative | (a-2) | (f-2) | Phosphoric | Performed | (s-2 | 1800 | 0.4 |
| Example 2 | (AM/AN/AA = | | acid | | | | |
| | 73/25/2) | | | | | | |
| Comparative | (a-3) | (f-4) | Phosphoric | Performed | (s-4) | 1800 | 0.3 |
| Example 3 | (AM/AN/AA = | | acid | | | | |
| | 65/33/2) | | | | | | |
| Comparative | (a-1) | (f-1) | Phosphoric | None | (s-6) | 1350 | 1.8 |
| Example 4 | (AM/AN = | | acid | | | | |
| | 75/25) | | | | | | |
| Comparative | (8-1) | (f-5) | None | Performed | (s-7) | 1350 | 0.0 |
| Example 5 | (AMAN = | | | | | | |
| | 75:25) | | | | | | |
| Reference | — | — | — | — | — | 1400 | 0.0 |
| Example 1 | | | | | | | |
| Reference | — | — | — | — | — | 1500 | 0.0 |
| Example 2 | | | | | | | |
| Reference | — | — | — | — | — | — | 0.0 |
| Example 3 | | | | | | | |
| Reference | — | — | — | — | — | — | 0.0 |
| Example 4 | | | | | | | |

| | | | | Performance evaluation | | | |
|---|---|---|---|---|---|---|---|
| | | | | | Suppression | | |
| | | | | Carbon | of fluff | | |
| | | | | fiber | generation | Tensile | Tensile |
| | Element content (% by mass) | | | fusion | during | modulus | strength |
| | N | O | C | rate | unwinding | (GPa) | (GPa) |
| Example | 1.5 | 0.2 | 94.9 | 10 | B | 155 | 1.4 |
| 1 | | | | | | | |
| Example | 1.0 | 0.15 | 96.8 | 5 | A | 233 | 3.3 |
| 2 | | | | | | | |
| Example | 0.8 | 0.15 | 97.2 | 5 | A | 173 | 3.0 |
| 3 | | | | | | | |
| Example | 0.5 | 0.15 | 97.8 | 10 | A | 307 | 4.0 |
| 4 | | | | | | | |
| Example | 0.5 | 0.05 | 97.5 | 10 | A | 249 | 4.2 |
| 5 | | | | | | | |
| Example | 0.1 | 0.02 | 98.7 | 10 | B | 268 | 3.6 |
| 6 | | | | | | | |
| Example | 0.05 | 0.05 | 98.5 | 10 | B | 273 | 3.9 |
| 7 | | | | | | | |
| Comparative | 11.3 | 7.0 | 80.1 | 20 | B | 81 | 1.3 |
| Example 1 | | | | | | | |
| Comparative | 0.0 | 0.02 | 99.2 | 20 | C | 163 | 1.0 |
| Example 2 | | | | | | | |
| Comparative | 0.0 | 0.08 | 99.3 | 20 | C | 233 | 1.5 |
| Example 3 | | | | | | | |
| Comparative | 2.2 | 0.4 | 94.5 | 80 | C | 80 | 0.9 |
| Example 4 | | | | | | | |
| Comparative | 2.5 | 0.5 | 94 | 85 | C | 75 | 0.8 |
| Example 5 | | | | | | | |
| Reference | 3.1 | 0.3 | 96.4 | 0 | C | 230 | 3.3 |
| Example 1 | | | | | | | |
| Reference | 2.5 | 0.3 | 97.0 | 0 | C | 240 | 3.0 |
| Example 2 | | | | | | | |
| Reference | 6.9 | 0.2 | 92.2 | 0 | — | 230 | 3.5 |
| Example 3 | | | | | | | |
| Reference | 5.6 | 0.3 | 93.4 | 0 | — | 230 | 4.9 |
| Example 4 | | | | | | | |

As can be seen from Table 1, the carbon fiber of each Example containing phosphorus, oxygen, and nitrogen in the contents specified in the present disclosure had a low fusion rate, was suppressed in terms of fluff generation during unwinding, and was excellent in the tensile modulus and tensile strength of the single filament.

On the other hand, the carbon fiber of Comparative Example 1, which had a high nitrogen content, had a low tensile modulus, while the carbon fibers of Comparative Examples 2 and 3, which had low phosphorus contents, and the carbon fiber of Comparative Example 5, which did not contain phosphorus, had a high fusion rate and generated a lot of fluff when unwound.

Even with the phosphorus content within the appropriate range, the carbon fiber of Comparative Example 4, which was not subjected to fiber spreading and contained a large amount of oxygen, had a high fusion rate and generated a large amount of fluff when unwound. In all the evaluation items, the evaluation results were inferior to those of the Examples.

The present disclosure includes the following aspects.

<1> A carbon fiber, which has a phosphorus content of from 0.6% by mass to 10% by mass, a nitrogen content of 5% by mass or less, and an oxygen content of 0.3% by mass or less, obtained from elemental analysis of the carbon fiber, and which has a single filament tensile modulus of 150 GPa or more.

<2> The carbon fiber according to <1>, which is in a form of a carbon fiber bundle consisting of 800 fibers, in which a fusion rate of the carbon fibers included in the carbon fiber bundle is 15% or less.

<3> The carbon fiber according to <1> or <2>, which is a carbon fiber derived from an acrylamide-based polymer fiber.

<4> The carbon fiber according to any one of <1> to <3>, which has a single filament tensile strength of 1.4 GPa or more.

<5> A method of producing a carbon fiber, the method including performing a stabilization treatment on a spread fiber bundle prepared by fiber spreading of an acrylamide-based polymer fiber, in which the acrylamide-based polymer fiber has a phosphorus content of from 0.1% by mass to 10% by mass by elemental analysis.

<6> The method of producing a carbon fiber according to <5>, further including performing a carbonization treatment on the stabilized acrylamide-based polymer fiber.

<7> The method of producing a carbon fiber according to <6>, in which the stabilized acrylamide-based polymer fiber has a phosphorus content of from 0.1% by mass to 10% by mass by elemental analysis, a maximum temperature when performing the carbonization treatment is in a range of from 1350° C. to 1650° C., and the carbonized fiber bundle has a carbon fiber fusion rate of 20% or less.

What is claimed is:

1. A carbon fiber, which has a phosphorus content of from 0.6% by mass to 10% by mass, a nitrogen content of 5% by mass or less, and an oxygen content of 0.3% by mass or less, obtained from elemental analysis of the carbon fiber, and
which has a single filament tensile modulus of 150 GPa or more.

2. The carbon fiber according to claim 1, which is in a form of a carbon fiber bundle consisting of 800 fibers, wherein a fusion rate of the carbon fibers included in the carbon fiber bundle is 15% or less.

3. The carbon fiber according to claim 1, which is a carbon fiber derived from an acrylamide-based polymer fiber.

4. The carbon fiber according to claim 1, which has a single filament tensile strength of 1.4 GPa or more.

5. A method of producing a carbon fiber, the method comprising performing a stabilization treatment on a spread fiber bundle prepared by fiber spreading of an acrylamide-based polymer fiber,
wherein the acrylamide-based polymer fiber has a phosphorus content of from 0.1% by mass to 10% by mass by elemental analysis.

6. The method of producing a carbon fiber according to claim 5, further comprising performing a carbonization treatment on the stabilized acrylamide-based polymer fiber.

7. The method of producing a carbon fiber according to claim 6, wherein:
the stabilized acrylamide-based polymer fiber has a phosphorus content of from 0.1% by mass to 10% by mass by elemental analysis,
a maximum temperature when performing the carbonization treatment is in a range of from 1350° C. to 1650° C., and
the carbonized fiber bundle has a carbon fiber fusion rate of 20% or less.
